(19) United States
(12) Patent Application Publication
(10) Pub. No.: US 2015/0228047 A1
(43) Pub. Date: Aug. 13, 2015

(54) DATA PROCESSING DEVICE, SEMICONDUCTOR DEVICE, DISPLAY DEVICE, CONTROL METHOD AND PROGRAM PRODUCT

(71) Applicant: KABUSHIKI KAISHA TOSHIBA, Tokyo (JP)

(72) Inventors: Yusuke Shirota, Yokohama (JP); Tatsunori Kanai, Yokohama (JP); Shiyo Yoshimura, Kawasaki (JP); Tetsuro Kimura, Tokyo (JP); Koichi Fujisaki, Kawasaki (JP); Junichi Segawa, Kawasaki (JP); Masaya Tarui, Yokohama (JP); Satoshi Shirai, Kawasaki (JP); Akihiro Shibata, Tokyo (JP)

(21) Appl. No.: 14/615,607

(22) Filed: Feb. 6, 2015

(30) Foreign Application Priority Data
Feb. 12, 2014 (JP) 2014-024873

(51) Int. Cl. G06T 1/20; G09G 3/20; G06T 7/00

(52) U.S. Cl. CPC G06T 1/20; G06T 7/0026; G09G 3/20; G09G 2340/16; G09G 2330/023; G09G 2320/103

(57) ABSTRACT

A data processing device according to embodiments may comprise: a processor that reconstructs a plurality of update requests for updating at least a part of a display into one or more update requests, or determine that the plurality of the update requests are unnecessary; and an update instruction unit that instructs to execute update processes of the display using the reconstructed one or more update requests.

### CROSS-REFERENCE TO RELATED APPLICATION(S)

This application is based upon and claims the benefit of priority from the Japanese Patent Application No. 2014-024873, filed on Feb. 12, 2014; the entire contents of which are incorporated herein by reference.

### FIELD

Embodiments described herein relate generally to a data processing device, a semiconductor device, a display device, a control method thereof, and a program product.

### BACKGROUND

Conventionally, for a data processing device such as a portable data processing device including a slate terminal, a tablet terminal, an electronic book terminal, a medical terminal, an electronic medical chart, or the like, an electronic POP (point of purchase advertising), an electronic shelf label (ESL), an digital poster and a digital signage, an electronic newspaper, a sheet display, a small server, a sensor node, or the like, improvement of power efficiency is an important technical issue.

### BRIEF DESCRIPTION OF THE DRAWINGS

FIG. 1 is a block diagram showing an example of an outline structure of a data processing device according to a first embodiment;

FIG. 2 is a schematic view showing a relationship between an OS, a device driver and an update controller according to the first embodiment;

FIG. 3 is a schematic view showing another relationship of the update controller according to the first embodiment;

FIG. 4 is a block diagram showing an example of an outline structure of the update controller according to the first embodiment;

FIG. 5 is a block diagram showing a structure example of the update controller according to the first embodiment;

FIG. 6 is an illustration showing examples of update requests with respect to three regions which do not overlap with each other;

FIG. 7 is an operation diagram according to a comparative example based on the update requests shown in FIG. 6;

FIG. 8 is an operation diagram according to the first embodiment based on the update requests shown in FIG. 6;

FIG. 9 is an illustration showing examples of update requests with respect to two region C which overlap with each other;

FIG. 10 is an operation diagram according to a comparative example based on the update requests shown in FIG. 9;

FIG. 11 is an operation diagram according to the first embodiment based on the update requests shown in FIG. 9;

FIG. 12 is an illustration showing an example of an update operation according to the first embodiment;

FIG. 13 is an illustration showing an operation example of a power control instruction unit according to the first embodiment;

FIG. 14 is an illustration showing an example where regions targeted by two update requests are neighbor;

FIG. 15 is an illustration showing an example where regions targeted by two update requests overlap with each other;

FIG. 16 is an illustration showing an example where regions targeted by two update requests are separated from one the other;

FIG. 17 is a block diagram showing an example of an outline structure of a data processing device according to a second embodiment;

FIG. 18 is a schematic view showing a relationship of the update controller according to the second embodiment;

FIG. 19 is an illustration showing a display update operation according to a comparative example;

FIG. 20 is an illustration showing a display update operation according to the second embodiment;

FIG. 21 is an illustration showing another display update operation according to the comparative example;

FIG. 22 is an illustration showing another display update operation according to the second embodiment;

FIG. 23 is an illustration showing an example of an update operation according to the second embodiment;

FIG. 24 is an illustration for explaining an outline of a display update operation according to a third embodiment and effects thereby;

FIG. 25 is an illustration showing an example of an update operation according to the third embodiment;

FIG. 26 is a schematic view showing a relationship between an application and an update controller according to a fourth embodiment;

FIG. 27 is an illustration for explaining an outline of a display update operation according to the fourth embodiment and effects thereby;

FIG. 28 is an illustration showing an example of an update request to be displayed certainly;

FIG. 29 is a diagram showing an example of an update operation according to an eight embodiment;

FIG. 30 is a diagram showing another example of the update operation according to an eight embodiment;

FIG. 31 is a block diagram showing an example of an outline structure of an update controller according to a ninth embodiment;

FIG. 32 is a diagram showing an example of an update operation according to the ninth embodiment;

FIG. 33 is a diagram showing another example of an update operation according to the ninth embodiment;

FIG. 34 is an illustration showing an example of an update request according to a tenth embodiment;

FIG. 35 is an illustration for explaining an outline of a display update operation according to the tenth embodiment and effects thereby;

FIG. 36 is a diagram showing an example of an update operation according to an eleventh embodiment;

FIG. 37 is a diagram showing an example of an update operation according to a twelfth embodiment;

FIG. 38 is an illustration showing an example of an update request according to a thirteenth embodiment;

FIG. 39 is an illustration for explaining division of an update request according to the thirteenth embodiment;

FIG. 40 is an illustration for explaining combination of an update request according to the thirteenth embodiment;

FIG. 41 is an illustration for explaining an outline of a display update operation according to the thirteenth embodiment and effects thereby; and

FIG. 42 is an illustration for explaining an outline of another display update operation according to the thirteenth embodiment and effects thereby.

### DETAILED DESCRIPTION

Exemplary embodiments of a data processing device, a semiconductor device, a display device, a control method thereof, and a program product will be explained below in detail with reference to the accompanying drawings.

### First Embodiment

As described above, generally, in a data processing device such as a portable data processing device including a slate terminal, a tablet terminal, an electronic book terminal, a medical terminal, an electronic medical chart, or the like, an electronic POP (point of purchase advertising), an electronic shelf label (ESL), an digital poster and a digital signage, an electronic newspaper, a sheet display, a small server, a sensor node, or the like, a power consumption relevant to a display is great. For example, under tight power constraint such as a case where a data processing device is driven using an energy harvesting technology such as a solar cell, or the like, an aggressive power saving with suppressing an extra power consumption in an operation at the time when a displayed content is changed becomes important.

By using a non-volatile electronic paper (hereinafter to be referred to as EPD) or a memory liquid crystal display capable of storing a displayed content even when power is turned off or changed to low at the time when the displayed content is not changed, for instance, it is possible to suppress the power consumption during a standby time such as when a user browses the display, the displayed content is not changed, or the like. Also, by using a low-power display capable of operating at a low refresh rate, such as the IGZO (registered trademark), it is possible to reduce the power consumption of the data processing device. In the low power display, it is possible to maintain the displayed content by executing a periodic update several times per second to once each several seconds or at lowered refresh rate.

However, a simple use of the display with a low standby power requirement may be insufficient. For example, because update of a display requires a comparatively large power consumption, in a portable data processing device, how the power consumption for display updating can be reduced is a technical issue.

For example, in a display such as an electronic paper of which an update time is comparatively long as several 100 ms to several seconds, when an update request arrives from an application in a comparatively short cycle, powers and clocks may be continuously supplied to modules associating with updating the electronic paper, an electronic paper controller, or the like. In such case, the aggressive power saving in which the powers and the clocks are stopped during the idle time without updating the electronic paper may be difficult.

Furthermore, in the electronic paper, when collisions of update processes occur often, a total update time may become long, and thereby, a period of time for an aggressive power saving may become short. For example, in a display capable of executing a partial updating in which a part of a screen is updated, when update target regions in update requests which are close in terms of time overlap with one another, a later update process cannot be started before a prior update process is finished, and a phenomenon where the update processes collide with each other. This is a collision of update processes. When such collision occurs, because there is a necessary of detecting such collision using the electronic paper controller, or the like, and reexecuting the later update process on a device driver, or the like, the total update time may be extended. As a result, the period of time for the aggressive power saving may become short.

In a low power display operation capable of operating at a low refresh rate, such as the IGZO (registered trademark), because frequent update requests from the application rises a frequency of update, an update process other than the periodic updates may occur, and as a result, the power consumption may increase.

Therefore, in the following embodiments, by optimizing a plurality of update processes, the update time may be shortened. Thereby, because it is possible to reduce the power consumption for updating the display and extend the idle time for the aggressive power saving, it is possible to improve a power performance of the data processing device with the display.

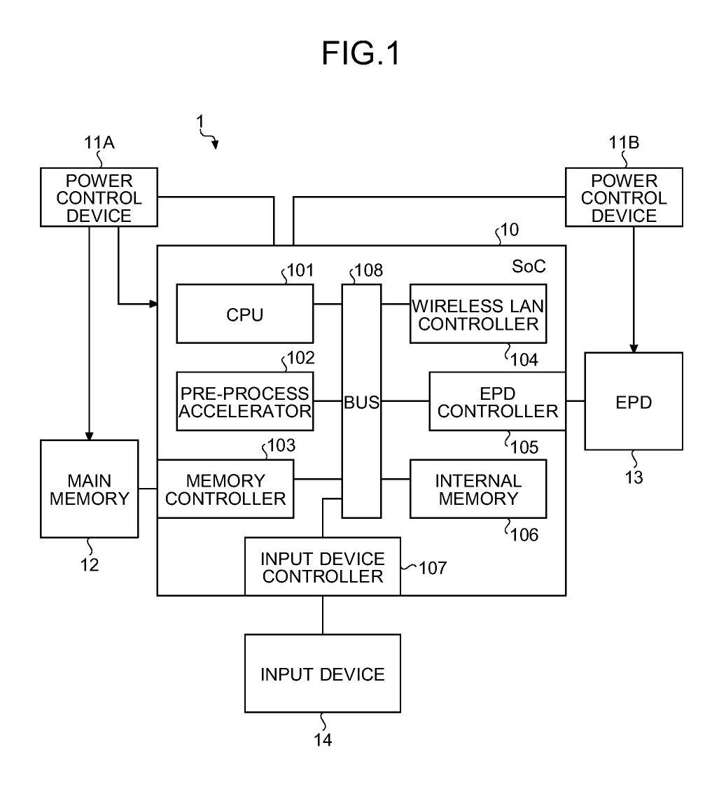

FIG. 1 is a block diagram showing an example of an outline structure of a data processing device according to a first embodiment. As shown in FIG. 1, a data processing device 1 has a SoC 10, a main memory 12, an EPD 13 being a display, power control devices 11A and 11B, and an input device 14.

The EPD 13 may be a display device capable of operating with extreme low power consumption, and it may be a display capable of maintaining a displayed content without power, for instance. As the displayed content without power, there is an electronic paper (hereinafter referred to as EPD (electronic paper display)), or the like. As a method of the electronic paper in the EPD 13, various kinds of methods such as an electrophoretic display, a quick response liquid powder display, a cholesteric liquid crystal display, or the like, can be applied. Alternatively a high-speed color EPD such as the Mirasol, or the like, can be applied. Outside of the electronic paper, the memory liquid crystal display, the low refresh rate display such as the IGZO (registered trademark), or the like, can be applied. In the following, as an example, a case where the EPD 13 is an electronic paper will be explained.

The input device 14 may be a touch panel capable of operating as a pointing device disposed on a surface of the EPD 13. The data processing device 1 may have a keyboard as another input device 14.

The main memory 12 may be a comparatively low power memory. As such memory, in a non-volatile memory, a power saving memory such as a MRAM (magnetoresistive random access memory), a ReRAM (resistance random access memory), or the like, exists. In a volatile memory, a DRAM (dynamic random access memory), or the like, exists. In the following, as an example, a case where the MRAM is used as the main memory 12 will be explained. On the main memory 12, data to be displayed on the EPD 31 (hereinafter referred to as update data) is located. Furthermore, on the main memory 12, EPD update control information being voltage control information such as a voltage value for applying a voltage for updating each pixel or a group of pixels in the EPD 13 from a state (grayscale value, for instance) to a specific state, a period of time for applying the voltage, or the like, is located.

The power control device 11A feeds power to the main memory 12 and the SoC 10, and the power control device 11B feeds power to the EPD 13. The power control devices 11A and 11B may be PMICs (power management integrated circuit), or the like. The power control device 11A can feed power to the EPD 13.

The data processing device 1 has an accumulator such as a solar cell and a capacitor, or the like, and it may operate using power generated by the solar cell. In such case, dump power generated by the solar cell during an idle time is stored in the accumulator, and the PMICs feed a combination power of the power stored in the accumulator and the power generated by the solar cell to each portion in the data processing device 1 to provide peak power consumption at an active operation. The data processing device 1 may operate with usage of a NFC (near field communication), or the like. In such cases, the aggressive power saving should be executed. Also, the data processing device 1 can have a battery-powered structure in that a battery, or the like, is used as the accumulator and the data processing device 1 operates using the accumulator. This is the same in the following embodiments.

The SoC 10 has a CPU 101, a memory controller 103, an EPD controller 105, a pre-process accelerator 102 used for pre-process for the EPD (hereinafter simply referred to as pre-preprocess), an internal memory 106, a communication interface such as a wireless LAN controller 104, or the like, and an input device controller 107 controlling the input device 14; these being connected to each other via a bus 108.

For effective utilization of standby modes, the SoC 100 may provide a plurality of standby modes of which power consumptions at the standby modes and electricity costs for transiting/resuming to/from the standby modes are different.

The pre-process accelerator 102 converts update data located on the main memory 12 in order to display the update data on the EOD 13. In the pre-process, for example, a processing step of the update data being an image, a selection step of the EPD update control information, and so forth, are included. When the EPD 13 is a grayscale EPD, the processing step of update data may include a process of converting image data into a grayscale image data, a black-white (binary) image data, or the like, in order to display color image data on the grayscale EPD, a process of inverting a black-and-white image data, process of scaling image data for fitting a size of the image data to a display size of the EPD 13 or a size of an update region in a case where the EPD 13 is partially updated, or the like. Furthermore, the pre-process may include a process of generating update data, such as a rendering process in PDF data or a web browser, using the accelerator such as a GPU, a CPU, or the like, installed in the data processing device 1. The selection step of the EPD update control information may be a process executed with consideration of a feature such as a gradation number, or the like, of update data being an image, or the like, a surrounding temperature of the data processing device 1, or the like. For detecting the surrounding temperature, the data processing device 1 may have a temperature sensor. A part or all of the pre-process may be executed by the EPD controller 105. Also, a part or all of the pre-process may be executed by the CPU 101, but not executed by an accelerator, a GPU, or the like. These are the same in the following embodiments.

The EPD controller 105 uses the main memory 12 as a working memory. The EPD controller 105 loads pre-processed update data being an output of the pre-process executed by the pre-process accelerator 102, and update control information corresponding to selection information, which is another output of the pre-process, for selecting update control information from the working memory, and execute an update process of the EPD 13. When regions to be actually updated are not overlapped with each other, the EPD controller 105 can update a plurality of partial regions of the EPD 13 in parallel. In the first embodiment, the partial regions capable of being updated are rectangular regions. However, shapes of the partial regions are not limited to the rectangular regions. Each update process of each rectangular region executed in parallel is handled by each update engine installed in the EPD controller 105 assigned by a device driver, or the like, of the EPD controller 105.

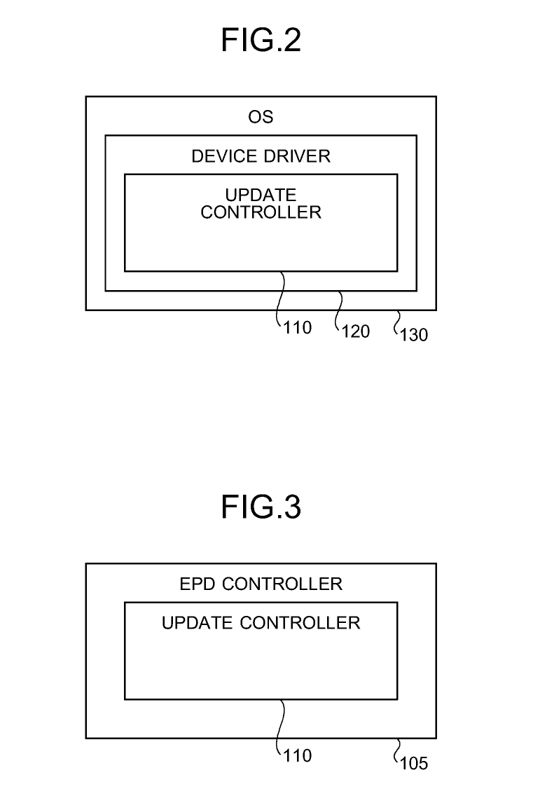

In FIG. 1, in the CPU 101, an update controller for controlling update of the EPD 13 is installed, for instance. The update controller may be one of device drivers of the EPD controller 105 in an operating system (hereinafter referred to as OS) executed on the CPU 101. FIG. 2 is a schematic view showing a relationship between an OS 130, a device driver 120 and an update controller 110 according to the first embodiment. However, as shown in FIG. 3, the update controller 110 is not limited to the configuration shown in FIG. 2, the update controller 110 may also be a module in the EPD controller 105.

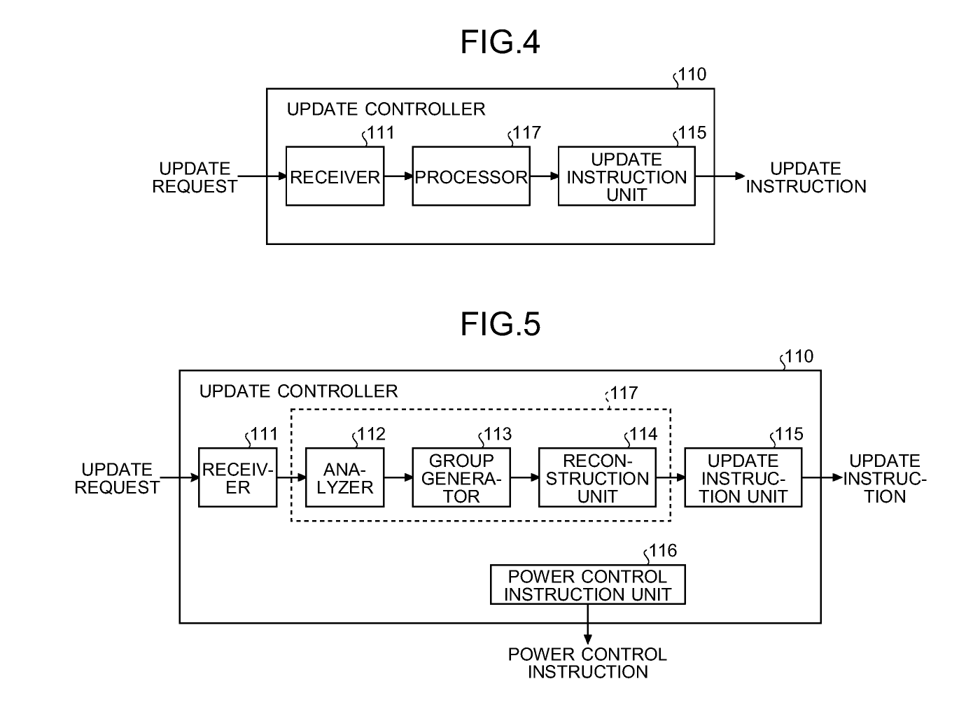

FIG. 4 is a block diagram showing an example of an outline structure of the update controller according to the first embodiment. As shown in FIG. 4, the update controller 110 has a receiver 111, a processor 117 and an update instruction unit 115.

The update controller 110 receives an update request, which is an update request for updating at least a part of the display device, explicitly issued from some kind of a middleware or an OS such as an application, an Android, or the like, which will be referred to as an application, or the like, in the following, operating on the data processing device 1, for instance, in order to update a part or all of an update target region of the EPD 13. The receiver 111 receives update requests (update requests for updating at least a part of the display device) intermittently issued from the application, or the like. The processor 117 generates one or more update requests by converting a plurality of update request received by the receiver 111. The processor 117 may determine that one or more update requests received by the receiver 111 are not necessary. For example, the processor 117 does not execute an update process of an initially received update request even if the update process can be executed, and after specific conditions are satisfied, the processor 117 converts one or more received update requests stored at that time into one or more update request, or cancels the one or more stored update requests at that time. That is, the processor 117 converts the one or more received update requests stored at that time into zero or more update request. For example, a plurality of update requests targets the same region, as the same region, the processor 117 generates a new update request using data indicated by the latter update request. The update instruction unit 115 instructs execution of an update process to the EPD controller 105 using the converted update request.

Next, detail structures of the update controller 110 shown in FIG. 4 will be shown in FIG. 5. FIG. 5 is a block diagram showing a structure example of the update controller according to the first embodiment. As shown in FIG. 5, the update controller 110 has an analyzer 112, a group generator 113 and a reconstruction unit 114 as the processor 117 in addition to the receiver 111 and the update instruction unit 115. The update controller 110 further has a power control instruction unit 116. In FIG. 5, although the receiver 111, the analyzer 112, the group generator 113, the reconstruction unit 114 and the update instruction unit 115 are connected by arrows, a process procedure in each unit is not limited to the arrows in FIG. 5, it is possible to transpose as necessary.

The analyzer 112 analyzes one or more update request received by the receiver 111. The group generator 113 divides the one or more update requests into one or more group (hereinafter referred to as update request group) using an analysis result, for instance. The reconstruction unit 114 reconstructs one or more update requests in each update request group based on conditions for reconstruction of the EPD 13. For example, the reconstruction unit 114 reconstructs the one or more update requests in each group using the analysis result of the analyzer 112 so that the total update time of each group becomes shorter. When the EPD controller 105 does not execute an update process, the power control instruction unit 116 conducts power saving during an idle time by instructing the power control devices 11A and 11B to stop power supply to modules associated with the EPD 13 including the EPD controller 105, the main memory 12, and so forth, or to stop clock supply to them.

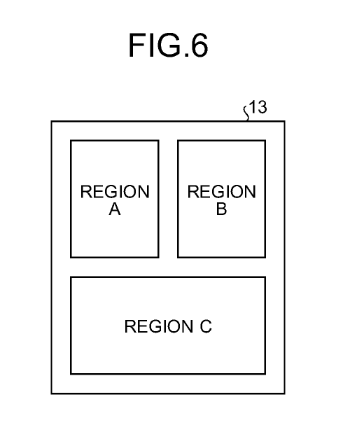

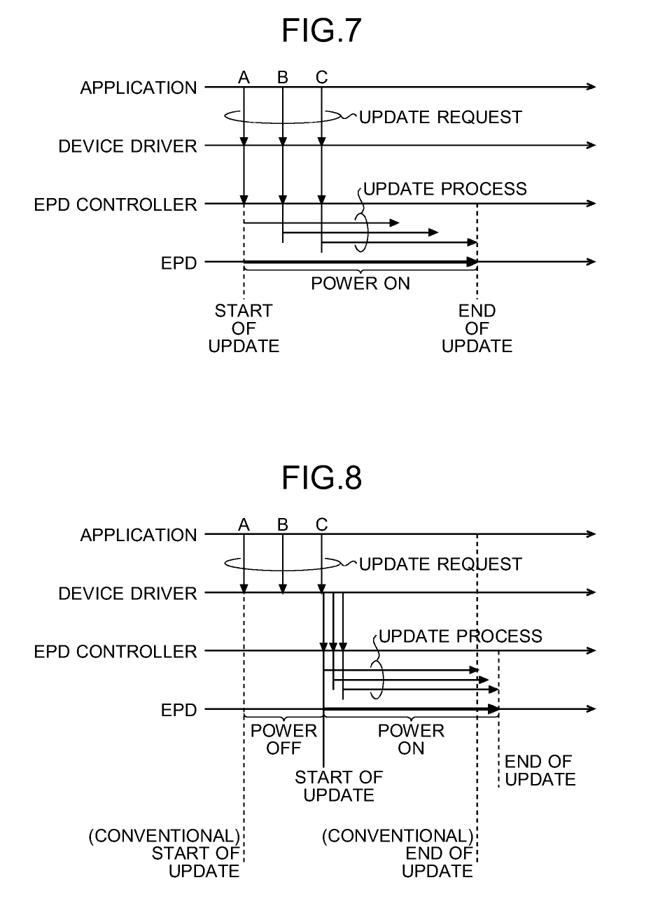

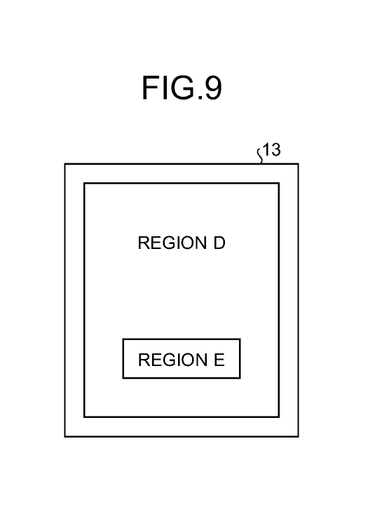

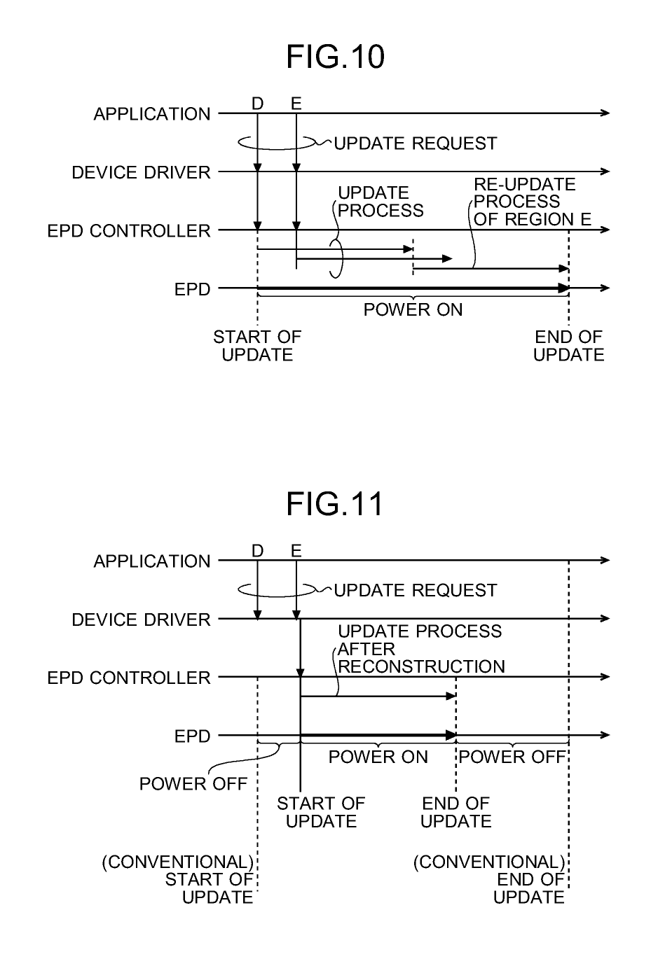

Next, with reference to FIGS. 6 to 11, an outline of the display update operation according to the first embodiment and effects thereby will be explained. FIGS. 6 to 8 show a case where three regions A to C which do not overlap with each other targeted to update requests which are comparatively close in terms of time, i.e., no collision occurs. FIGS. 9 to 11 show a case where regions D and E where at least a part of them overlap with each other are targeted to update requests which are comparatively close in terms of time, i.e., a collision occurs. Here, “close in terms of time” may mean that a time interval between arrival times of update requests issued by the application, or the like, to the device driver 120 of the EPD controller 105 is short. Furthermore, FIG. 7 and FIG. 10 show operations according to a comparative example in respective cases, and FIG. 8 and FIG. 11 show operations according to the first embodiment in respective cases. In the following, the update requests with respect to the regions A to E will be referred to as update requests A to E.

As shown in FIG. 6, when three regions A to C which do not overlapped with each other are targeted to update requests which are comparatively close in terms of time, in the comparative example without optimization of display update control, as shown in FIG. 7, when the update requests arrives the device driver 120 of the EPD controller 105, the device driver 120 directly instructs the EPD controller 105 to execute update processes of the EPD 13. In such case, because an update time of the EPD 13 is extremely short, after the update process of the update request A is started, the update processes of the update requests B and C are started before the update process of the update request A is finished. Therefore, the EPD 13 or the modules associating with updating the EPD 13 in the SoC 10 (hereinafter simply referred to as associated modules) are continuously powered by the power control device 11B or the power control device 11A till from starting the update process of the update request A to ending the update process of the update request C.

On the other hand, in the method with optimization of the display update control according to the first embodiment, as shown in FIG. 8, the analyzer 112 of the EPD controller 105 analyzes the plurality of the update requests A to C received by the receiver 111 via the device driver 120. Specifically, for example, the analyzer 112 determines whether partial regions to be updated based on the received update requests A to C overlap with each other or not. In the example, because the analyzer 112 detects that the partial regions do not overlap with each other, the analyzer 112 can determine that no collision occurs.

Then, the group generator 113 divides the plurality of the update requests into one or more update request groups. In the first embodiment, the group generator 113 groups the update requests which are close in terms of time into a single update request group. Specifically, the update controller 105 waits for a specific period of time without immediately executing the update processes even when update requests are received, and the analyzer 112 executes a determination process of the update requests having been stored during the waiting. A waiting time may be about several 10 ms to several 100 ms, for instance. Although an appropriate waiting time varies depending on various kinds of factors such as display characteristics, applications, or the like, the waiting time can be preset as a value appropriate for many applications, or as a value different by each application, or as a value can be dynamically changed based on an issue pattern of update requests which will be described later on. In the example, because the update requests A to C are determined as being close in terms of time, the update requests A to C are grouped into a single update request group. In the case where the waiting time is changed depending on application, a hint function described below can be used, for instance.

The reconstruction unit 114 reconstructs update requests in each update request group based on conditions of the EOD 13 for reconstruction. Specifically, for example, when the update requests in the update request group include update requests of which update target regions overlap with each other, the analyzer 112 analyzes whether the update requests of which the update target regions overlap with each other can be converted into a single update request including the overlapped update target regions or not. In the example, because the analyzer 112 determines that no update target region overlaps, the reconstruction unit 114 does not reconstruct the update requests A to C.

The update instruction unit 115 transmits three instructions for executing update processes to the EPD controller 105 once using the update requests A to C passed through the reconstruction unit 114. The three instructions of the update processes may be outputted at the same time, or outputted with a short time lag. Thereby, it is possible to further concentrate start timings of updates as compared to the method according to the comparative example. Because it is possible to align (further overlap) updating terms by aligning the start timings of the updates, it is possible to shorten the total update time for the update processes. Thereby, it is possible to shorten terms of supplying power or clocks to the EPD 13 from the power control device 11B or to the associated modules from the power control device 11A. As a result, it is possible to increase the idle time of the display and reduce the power consumption for updating the EPD 13. In the drawings, although the updating terms may be expanded, because the extended time is very short, effects on the power consumption and the usability due to the extensions of the update terms can be ignored.

As shown in FIG. 9, when the update requests for the regions D and E in the display 30, of which at least parts of them overlap with each other, are comparatively close in terms of time, in the comparative example without optimization of the display update control, as shown in FIG. 10, if the update processes of the EPD 13 are directly instructed to the EPD controller 105, because the two partial regions overlap with each other, a collision where the update process of the update request E collides with the update process of the prior update request D occurs. In such case, because there is a necessity of re-instructing the EPD controller 105 to execute the update process E (hereinafter referred to as a re-update process E′) when the update process D is finished, around twice the update time for a single update process will be required for the two update processes. Thereby, for the whole time, the EPD 13 or the associated modules in the SoC 10 are continuously powered by the power control device 11B or the power control device 11A.

On the other hand, in the method with optimization of the display update control according to the first embodiment, as shown in FIG. 11, as a result of analyzing the update requests D and E, the analyzer 112 detects that at least parts of the update target regions of the update requests D and E overlap with each other and/or the region D includes the region E. In such case, the analyzer 112 can determine that execution of the update processes without reconstruction will bring on a collision. Therefore, the group generator 113 determines that the update requests D and E are close in terms of time, and groups these update requests D and E into the single update request group.

The reconstruction unit 114 reconstructs one or more update requests in each update request group based on conditions for reconstruction of the EPD 13. In the example, because the analyzer 112 determines that the region D includes the region E, the reconstruction unit 114 combines the two regions D and E, and reconstructs the two update requests D and E into a single update request (D+E) of the single regions D.

The update instruction unit 115 instructs the EPD controller 105 to execute the single update process using the update request (D+E) unified by the reconstruction. Because the update processes are unified by the reconstruction, no collision occurs, and thereby, it is possible to greatly shorten the update time as compared with the update time in the comparative example with the re-update process caused by a collision. Thereby, the power control instruction unit 116 can instruct the power control device 11B to shorten the terms of supplying power or clocks to the EPD 13 from the power control device 11B, or to shorten the terms of supplying power or clocks to the associated modules from the power control device 11A. As a result, it is possible to increase the idle time of the display and reduce the power consumption for updating the EPD 13.

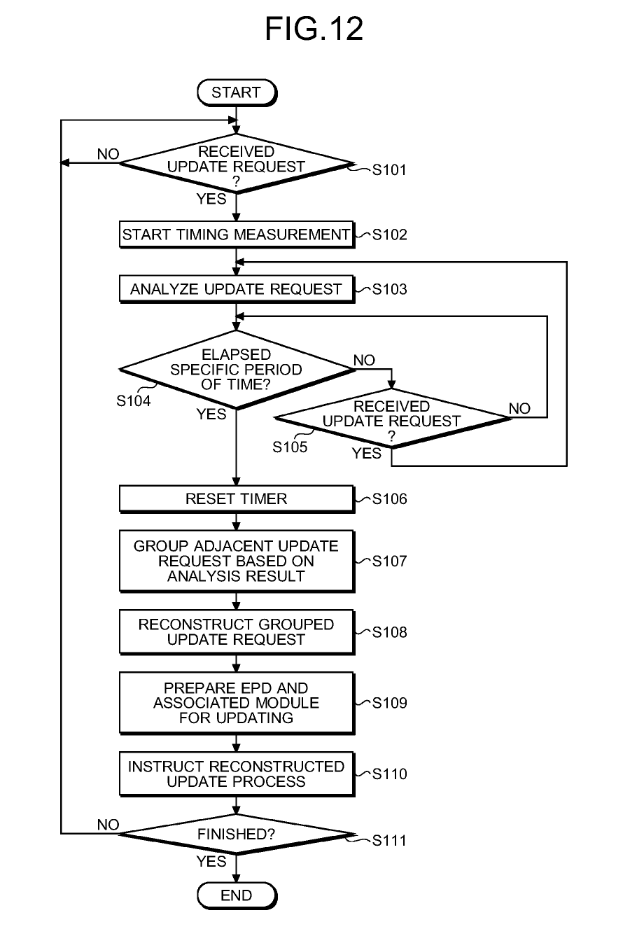

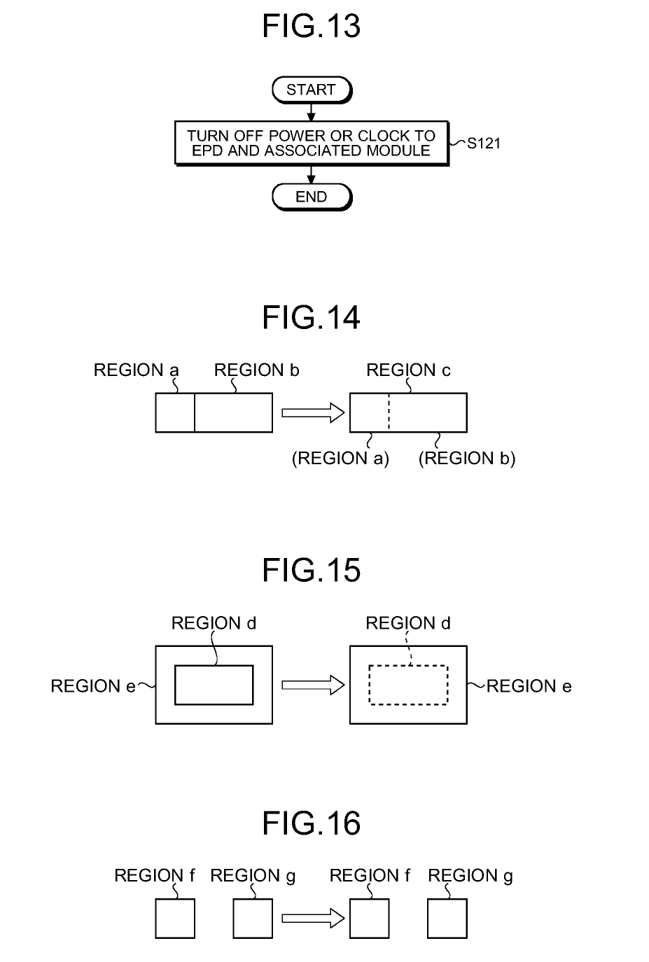

Next, an update operation according to the first embodiment will be explained with reference to the accompanying drawings. FIGS. 12 and 13 are flowcharts showing examples of update operations according to the first embodiment. FIG. 12 shows an operation example of the receiver 111, the analyzer 112, the group generator 113, the reconstruction unit 114 and the update instruction unit 115 in the update controller 110, and FIG. 13 shows an operation example of the power control instruction unit 116 in the update controller 110.

The update operation by the update controller 110 is started when an update request is issued to the update controller 110 from an application. The update request includes an instruction for updating an update target region of the EPD 13 using update data of the EPD 13 located in a frame buffer on the main memory 12, or the like, for instance. This is the same in the following embodiments.

As shown in FIG. 112, firstly, the receiver 111 waits an update request which are intermittently issued from an application (step S101; NO), and when the receiver 111 receives the update request (step S101; YES), the receiver 111 starts a measurement of an elapsed time using a timer, or the like (step S102). The timer may be reset at the time of booting the data processing device 1. The analyzer 112 analyzes the update request received by the receiver 111 (step S103). In an analysis result, a position and a content of a partial region to be updated by the received update request, for instance. The update request and the analysis result are stored in a specific memory, or the like. At this time, when an update request and an analysis result with respect to the same partial region are previously stored, the stored update request and the stored analysis result may be overwritten by the last update request and the last analysis result.

After that, the receiver 111 determines, by referring the timer, whether a specific period of time has been elapsed or not (step S104), and repeats receptions of update processes till the specific period of time has been elapsed (step S104; NO, and step S105; NO). When the receiver 111 receives an update request before the specific period of time has been elapsed (step S105; YES), the analyzer 112 returns to step S102, and analyzes the newly received update request.

On the other hand, the specific period of time has been elapsed (step S104; YES), the receiver 111 resets the time (step S106), and stops the measurement of the elapsed time. The group generator 113 groups the update requests received with the specific period of time into a single update request group based on the analysis result stored in the specific memory, or the like (step S107). That is, in the first embodiment, one or more update requests stored within the specific period of time are determined as being close in terms of time, and grouped into a single group.

Then, the reconstruction unit 114 reconstructs the one or more update requests grouped into the single update request based on the analysis result stored in the specific memory, or the like (step S108). In this reconstruction, the one or more update requests are converted an update request without the occurrence of a collision. For example, when a partial region updated by the EPD controller 105 once is rectangular, by combining an union of partial regions to be updated by a plurality of update requests into one or more rectangular regions, it is possible to convert a plurality of update requests in the update request group into one or more update requests. Here, the number of reconstructed update requests is equal to or smaller than the number of pre-reconstruction update requests.

When a set of new update requests by reconstructing the update requests is prepared, the power control instruction unit 116 sets the EPD 13, the associated modules, and so forth, to a state ready for update (step S109). Specifically, for example, the power control instruction unit 116 executes, when the power control devices 11A and 11B are in a power saving mode, return processing for returning to a normal operation mode, and starts power supply to the EPD 13 by instructing the power control device 11B. Furthermore, when the power supply from the power control device 11A is stopped, the power control instruction unit 116 feeds power to the associated modules by instructing the power control device 11A. The associated modules include the main memory 12 constructed from a non-volatile memory such as a MRAM, or the like, the EPD controller 105, the pre-process accelerator 102, or the like. These operations may be the same as clock supply to the EPD 13 and the associated modules.

When update processes become executable by the above-described ready operation, the update instruction unit 115 instructs the EPD controller 105 to execute the update processes using the reconstructed update requests (step S110). Thereby, the EPD controller 105 starts the update processes. After that, the update controller 110 determines whether the operation should be finished or not (step S111), when the operation should not be finished (step S111; NO), the update controller 110 returns to step S101, and executes the following steps.

After that, when the update processes are finished and the power control instruction unit 116 receives a notice of termination of the update processes from the EPD controller 105 by interrupt handling, or the like, as shown in FIG. 13, the power control instruction unit 116 sets the power of the associated modules as a low state (step S121). Specifically, for example, the power control instruction unit 116 stops the power supply to the EPD 13 by instructing the power control device 11B. Furthermore, for example, the power control instruction unit 116 stops the power supply to the associated modules or lets the associated modules transit to a power saving mode by instructing the power control device 11A. These operations are the same as the clock supply to the EPD 13 and the associated modules.

Here, the reconstruction in step S108 of FIG. 12 will be explained with a specific example. As shown in FIG. 14, when rectangular regions a and b being targeted to two update requests neighbor, the reconstruction unit 114 reconstructs (combines) the update requests while defining a rectangular region generated by combining the two regions a and b into a single region c as a converted update target region. Furthermore, as shown in FIG. 15, when a single region e includes other region d, the reconstruction unit 114 reconstructs the update requests while defining one region larger than the other region in an inclusive relation between the regions d and e as a converted update target region. In such case, the update request with respect to the smaller included region d may be abandoned. As shown in FIG. 16, when the two regions a and b are separated, the reconstruction unit 114 does not combine the update target regions. In such case, the reconstruction of the update requests may be not executed.

As described above, according to the first embodiment, by optimizing update processes by reconstructing a plurality of update requests, it is possible to shorten the update time. As a result, because it is possible to reduce the power consumption for updating the display and extend the idle time for the aggressive power saving, it is possible to improve a power performance of the data processing device with the display.

In the above-described configuration, the EPD controller 105 of the data processing device 1 can be located outside the SoC 10. The EPD controller 105 can include a working buffer, a dedicated memory storing a waveform, or the like. Furthermore, a structure in that a microcontroller, or the like, of which power consumption is smaller than that of the SoC 10 controlling the EPD controller 105 can be applied, another alternative structures can also be applied. These are the same in the following embodiments.

Moreover, in the first embodiment, although the EPD-based data processing device 1 with the input device 14 is explained as an example, a structure according to the first embodiment is not limited to such arrangement. This is the same in the following embodiments.

Moreover, in the first embodiment, although one or more update requests received within a specific period of time since reception of an initial update request in the update requests to be grouped into a single group are grouped into a single update request group, the arrangement is not limited such. For example, it is also acceptable that update requests received within each preset constant time slot are grouped into a single update request group. This is the same in the following first embodiments.

Moreover, although software is being an example of an implementation of the update controller 110, the update controller 110 can also be installed as hardware. For example, the update controller 110 can be integrated into the EPD controller 105. This is the same in the following embodiments.

### Second Embodiment

Next, a data processing device, a display device, a semiconductor device, a control method and a program product according to a second embodiment will be described in detail with reference to the accompanying drawings. In the second embodiment, a data processing device having a low-power display capable of operating at a low refresh rate (hereinafter referred to as a low refresh rate display) such as a display using an IGZO (registered trademark), a memory liquid crystal display, or the like, will be explained as an example.

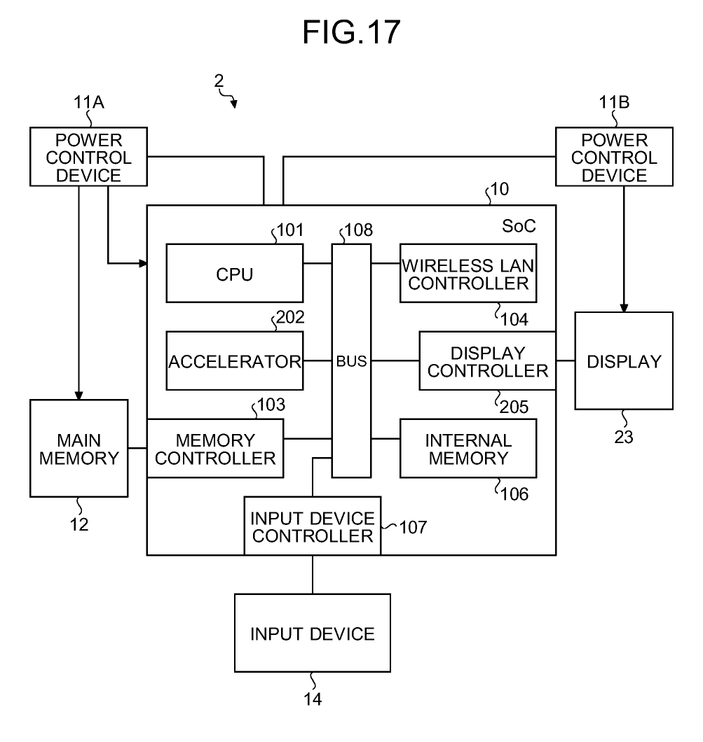

FIG. 17 is a block diagram showing an example of an outline structure of a data processing device according to the second embodiment. As is evident from comparison of FIGS. 17 and 1, the data processing device 2 according to the second embodiment has the same structure as that of the first embodiment, except for the EPD 13 is replaced with a display 23, and the accelerator 102 and the EPD controller 105 in the SoC 10 are replaced with an accelerator 202 and a display controller 205, respectively.

As described above, the display 23 is the low refresh rate display capable of operating at a low refresh rate such as an IGZO (registered trademark), a memory display, or the like. The display controller 205 updates, differentially from the EPD controller 105, for instance, the whole screen of the display 23 in response to a signal update request. However, it is not limited to such arrangement, and it is also possible that the display controller 205 can update a part of the screen. The accelerator 202 may be a graphics accelerator for display 23, or an accelerator executing other processes in the data processing device 2.

A structure of an update controller in the second embodiment may be the same structure as the update controller 110 explained using FIG. 5 in the first embodiment. Although characteristics of the EPD 13 differs from characteristics of the display 23 being the low refresh rate display, basic concepts of power saving are the same.

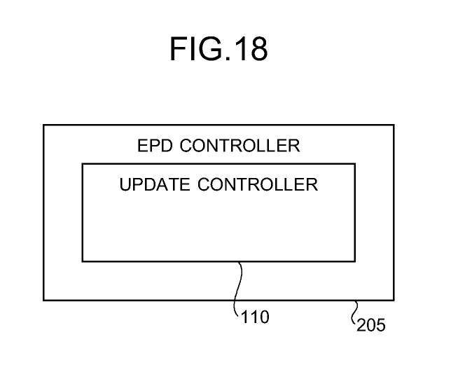

The update controller 110 may be one of device drivers of the display controller 205 in an OS operating on the CPU 101, or the like. Or, as shown in FIG. 18, the update controller 110 may be a module in the display controller 205.

In the second embodiment, the update controller 110 operates by receiving an update request for updating the whole screen of the display 23 from an application, or the like, operating on the data processing device 1, for instance. The receiver 111 receives update requests intermittently issued from the application, or the like. The analyzer 112 analyzes the plurality of the update requests received by the receiver 111. The group generator 113 groups the plurality of the update requests into one or more update request group using an analysis result, for instance. The reconstruction unit 114 reconstructs one or more update requests in each update request group based on conditions for reconstruction of the display 23. For example, the reconstruction unit 114 reconstructs the one or more update requests in each group using the analysis result of the analyzer 112 so that the total update time of each group becomes shorter. The update instruction unit 115 instructs the display controller 205 to execute update processes using the reconstructed update requests. When the display controller 205 does not execute an update process, the power control instruction unit 116 conducts power saving during an idle time by instructing the power control devices 11A and 11B to stop power supply to modules associated with the display 23 including the display controller 205, the main memory 12, and so forth, or to stop clock supply to them.

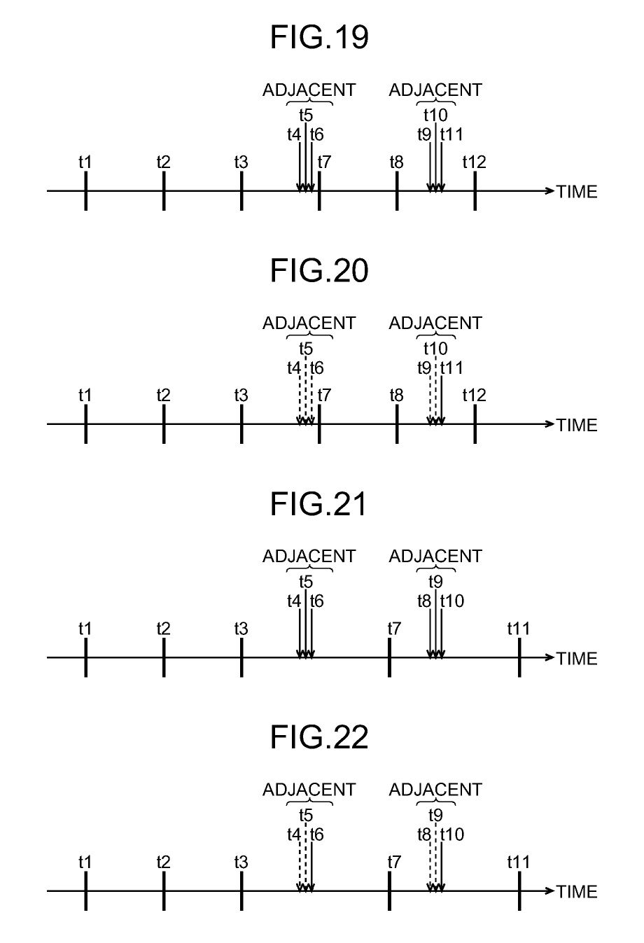

Next, with reference to FIGS. 19 to 22, an outline of the display update operation according to the second embodiment and effects thereby will be explained.

Firstly, an example of an update operation according to the comparative example without optimization of display update control is shown in FIG. 19. In FIG. 19, periodical update processes (hereinafter simply referred to as refresh) for holding a displayed content in the low refresh rate display such as the IGZO (registered trademark), or the like, are shown by using heavy lines, and timings thereof are defined as times t1, t2, t3, t7, t8 and t12, respectively. Intervals between times t1, t2, t3, t7, t8 and t12 are constant. In the example shown in FIG. 19, in addition to such periodical refreshes, three update requests intensively issued for each of two regions from the application, or the like, respectively, arrive the device driver of the display controller 205. Timings thereof are defined as times t4, t4, t6, t10 and t11, respectively. In the method according to the comparative example, as shown in FIG. 19, when the update requests are arrived, executions of update processes are directly and explicitly instructed to the display controller 205. Therefore, due to the number of updates increasing, the power consumption becomes large.

Next, an example of a display update operation according to the second embodiment with optimization of the display update control is shown in FIG. 20. In FIG. 20, as FIG. 19, in addition to the periodical refreshes at the times t1, t2, t3, t7, t8 and t12, update requests are issued by the application, or the like, at the times t4, t5, t6, t9, t10 and t11. The analyzer 112 analyzes the plurality of the update requests received by the receiver 111. Specifically, the analyzer 112 calculates an interval between a reception time of each received update request and a schedule time of a next periodical update process, and determines how close the received update requests and the next periodical update process are. As a result, in the example shown in FIG. 19, the time t6 is close to the time t7 being a schedule time of an immediate periodical update process, and the time t11 is not close to a schedule time of an immediate periodical update process.

Then, the group generator 113 groups the plurality of the update request into one or more update request groups. In this example, the group generator 113 groups update requests which are close in terms of time into a single update request group. Specifically, the update controller 205 waits for a specific period of time without immediately executing the update processes even when update requests are received, and the analyzer 112 executes determination process of the update requests having been stored during the waiting. A waiting time may be about several 10 ms to several 100 ms, for instance. Therefore, in the example shown in FIG. 20, the update requests at the times t4, t5 and t6 are determined as close in terms of time, and grouped into an initial update request group. Furthermore, the update requests at the times t9, t10 and t11 are determined as close in terms of time, and grouped into a second update request group.

The reconstruction unit 114 reconstructs one or more update requests in each update request group based on conditions for reconstruction of the display 23. Because the display controller 205 according to the second embodiment updates the whole screen of the display 23, with respect to the update requests at the times t4, t5 and t6, by executing the update request at the time t6, it is possible to display a content to be displayed finally. Therefore, the reconstruction unit 114 just has to convert the update requests at times t4 to t6 into the update request at the time t6.

In the example shown in FIG. 20, from the analysis result by the analyzer 112, the update request at the time t6 and a refresh at the time t7 are determined as close in terms of time. Therefore, by skipping an update process of the update request at the time t6 and executing the refresh at the time t7, a “feels like” display speed for a user is not dynamically changed. The reconstruction unit 114 abandons the initial update request group. As the result, the update requests at the times t4 to t6 are abandoned, and the refresh at the time t7 is executed. Thereby, because the four update processes required in the method according to the comparative example (including the refresh) is reduced to a single update process (the refresh), and it is possible to update the screen by the same number of updates as the number for continuously displaying a still image (i.e., the same power consumption), it is possible to drastically reduce the power consumption.

On the other hand, regarding the second update request group, as the result of the analysis by the analyzer 112, because the update request at the time t11 and the refresh at the time t12 are not close in terms of time, the update requests at the times t9, t10 and t11 may be converted into the update request at the time t11. Also, in such case, because the three update processes required in the method according to the comparative example becomes the single update process, it is possible to drastically reduce the power consumption. Furthermore, because a period of time for updating the display 23 being the low refresh rate display is shorten, directly after the update processes are finished, it is possible to shorten terms of supplying power or clocks to the EPD 13 from the power control device 11B or to the associated modules from the power control device 11A. As a result, a further power saving becomes possible.

Although FIGS. 19 and 20 show a case where the periodical refreshes are executed with no relation to timings of explicit update processes for changing the displayed content, FIGS. 21 and 22 show a case where refreshes are executed after a specific period of time is elapsed from the point where explicit update processes for changing the displayed content is finished without changes of the displayed content. Specifically, at the time t8 after the specific period of time is elapsed from the explicit update at the time t7 in FIG. 21, the refresh is executed. Also, in such case, as shown in FIG. 22, it is possible to apply the same method as the method explained using FIG. 20.

Next, an update operation according to the second embodiment will be described in detail with reference to the accompanying drawings. In the following, for the same operation as the operation shown in FIG. 12, by referring to them, the redundant explanations thereof will be omitted. Furthermore, because an operation example of the power control instruction unit 116 is the same as the operation explained using FIG. 13 with replacement of the EPD 13 with the display 23, the detailed explanations will be omitted.

An update operation by the update controller 110 is started when an explicit update request for updating the whole screen of the display 23 using data to be displayed on the display 23, which is located on a frame buffer, or the like, on the main memory 12 is issued from the application, or the like, to the update controller 110. This is the same in the following embodiments.

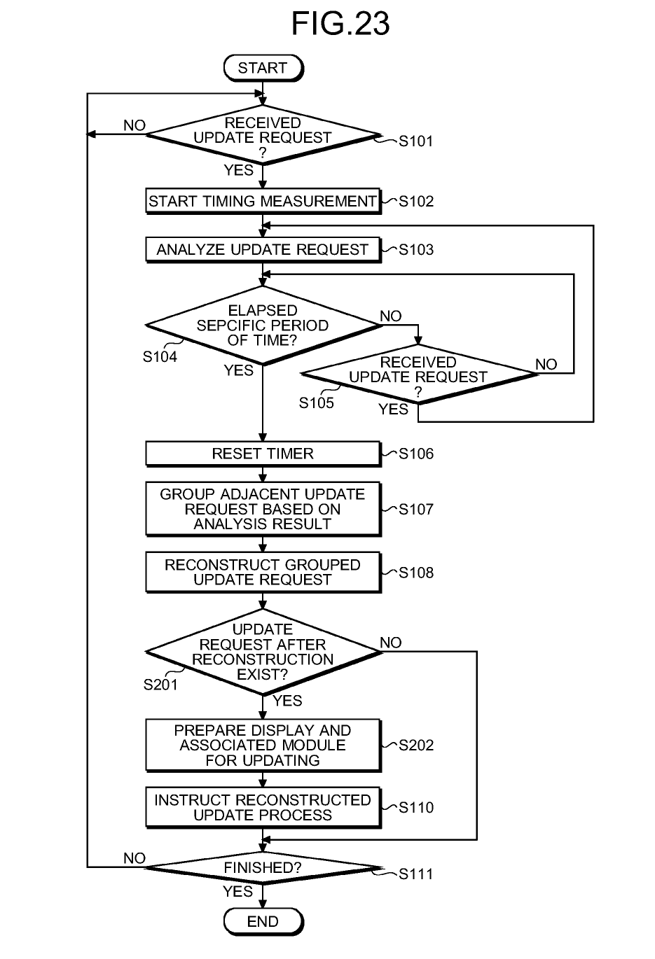

FIG. 23 is a flowchart showing an example of an update operation according to the second embodiment. As shown in FIG. 23, in the second embodiment, by the same operation as those in steps S101 to S108 of FIG. 12, update requests received within the specific period of time are reconstructed. In a case where the whole screen of the low refresh rate display such as the IGO (registered trademark) can be updated, update requests in each update request group are converted into the last update request in each update request group, for instance. Based on the analysis result by the analyzer 112, when the last update request is close to a next periodical refresh, the update requests in the update request group including the last update request are abandoned.

When a set of new update requests by reconstructing the update requests is prepared, the update instruction unit 115 determines whether one or more update requests exist in the reconstructed update request group or not (step S201), and when one or more update request exist (step S201; YES), as step S109 in FIG. 12, the power control instruction unit 116 sets the EPD 13, the associated modules, and so forth, to a state ready for update (step S202), and then, as step S110 in FIG. 12, after the reconstructed update process is instructed to the display controller 205, the update controller 110 progresses to step S111. On the other hand, when no update request exists in the reconstructed update request group (step S201; NO), the update controller 110 directly progresses to step S111. In step S111, the update controller 110 determines whether the operation should be finished or not, and when the operation should not be finished (step S111; NO), the update controller 110 returns to step S101, and executes the following steps.

As described above, according to the second embodiment, for the data processing device 2 with the low refresh rate display such as the IGZO (registered trademark), as the first embodiment, by optimizing update processes by reconstructing a plurality of update requests, it is possible to shorten the update time. As a result, because it is possible to reduce the power consumption for updating the display and extend the idle time for the aggressive power saving, it is possible to improve a power performance of the data processing device with the display.

In the above-described configuration, the display 23 is not limited to the low refresh rate display, and a memory liquid crystal display, or the like, for instance, can be applied to the display 23. This is the same in the following embodiments.

Moreover, although software is being an example of an implementation of the update controller 110, the update controller 110 can also be installed as hardware. For example, the update controller 110 can be integrated into the display controller 205. This is the same in the following embodiments.

### Third Embodiment

Next, a data processing device, a display device, a semiconductor device, a control method and a program product according to a third embodiment will be explained in detail with reference to the accompanying drawings. In the first or second embodiment, the update controller 110 waits for a specific period of time, and groups update requests stored in the specific period of time. On the other hand, in the third embodiment, as another method, an update controller waits for the specific number of update requests, and groups the specific number of update processes into a single update request group.

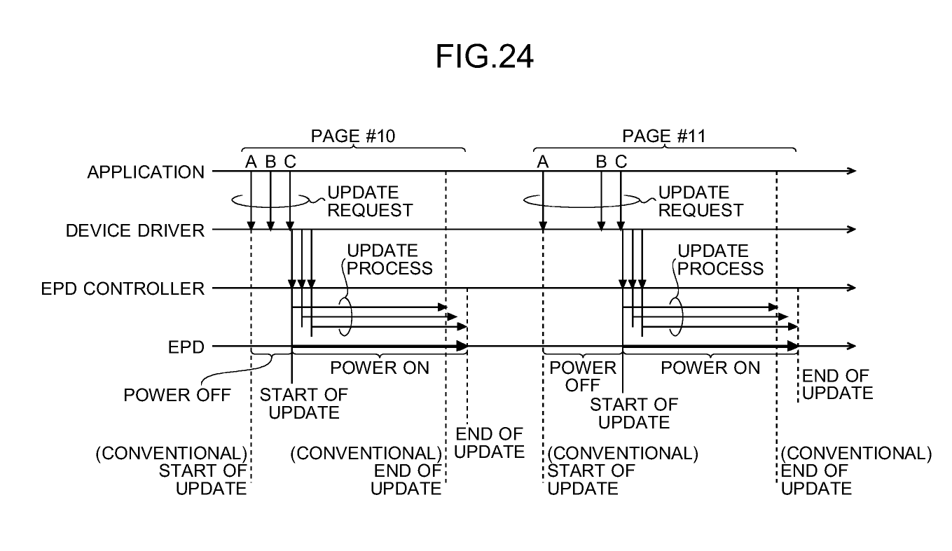

FIG. 24 is an illustration for explaining an outline of a display update operation according to the third embodiment and effects thereby. The example shown in FIG. 24 is an example where an electronic book application is executed on the data processing device 1 shown in FIG. 1, for instance. In FIG. 24, it is assumed that a page #10 and a page #11 of an electronic book are displayed, and update processes of three regions A, B and C issued from the application are executed for updating each page. It is also assumed that the regions A to C do not overlap with each other. In such case, the device driver 120 of the EPD controller 105 instructs in one time, after the third update request for the region C is arrived, to execute the three update processes for the regions A to C. As a result, the three update processes are executed in parallel. Such flow will be repeated for every page flipping.

In FIG. 24, intervals between arrivals of the three update requests are different in each of the pages #10 and #11. This is because there are cases where a process time of rendering for creating a page to be displayed is changed depending on a content of each page, another process is executed in the background, or the like. In such repetition processing of which the number of updates for each time is preset, an interval between update requests may be different by every page. In the third embodiment, by waiting a certain number of update requests, even when the interval between update requests may be different by every page, it is possible to improve the power performance without being influenced by the difference of the intervals.

The update controller according to the third embodiment may put instructions of update processes on hold till a preset number of update requests (hereinafter referred to as an update request number) are stored. Because an appropriate update request number depends on the application, or the like, the application, or the like, may notify the appropriate update request number to the update controller (device driver) as hint information, or the like. The hint information is various kinds of information about update process. The hint information may be transmitted with update requests, or be notified separately from update requests. Furthermore, as described later on, it is also possible that the number of update processes is recorded as a history for every action, and the appropriate number of update requests is dynamically changed by referring to the history.

Next, an update operation according to the third embodiment will be described in detail with reference to the accompanying drawings. In the following, for the same operations as the operations shown in FIG. 12 or 23, by referring to them, the redundant explanations thereof will be omitted. Furthermore, because an operation example of the power control instruction unit 116 is the same as the operation explained using FIG. 13, the redundant explanations will be omitted.

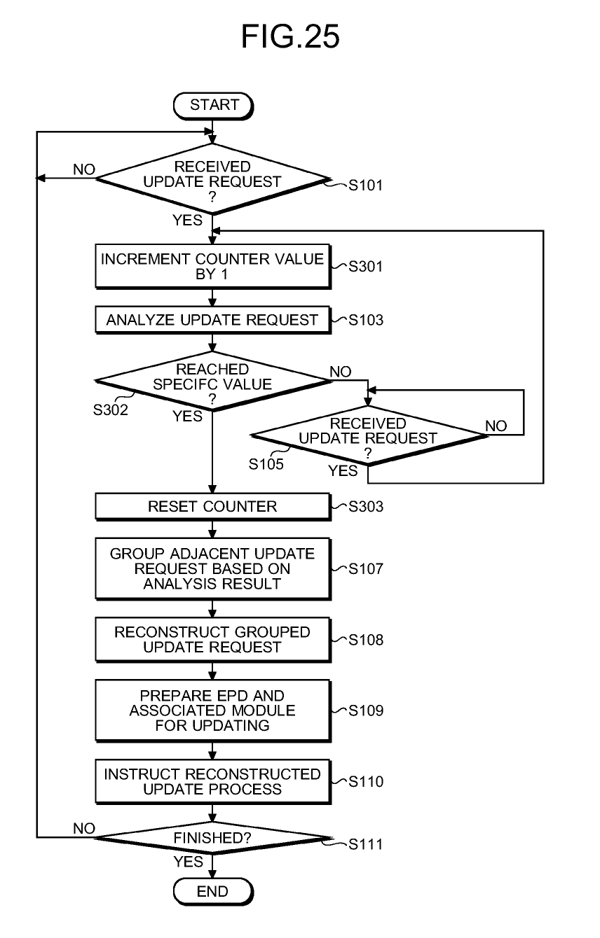

FIG. 25 is a flowchart showing an example of the update operation according to the third embodiment. As shown in FIG. 25, in the third embodiment, by the same operation as the operation in step S101 of FIG. 12, the receiver 111 waits an update request from the application, or the like. When the receiver 111 receives the update request (step S101; YES), the receiver 111 increments a counter value of a counter by 1 (step S301). Here, the counter may be reset at the time of booting the data processing device. Then, as step S103 of FIG. 12, the analyzer 112 analyzes the received update request. Then, the receiver 111 determines whether the number of the received update requests reaches a certain number or not (step S302). The certain number may be a number notified from the application, or the like, as described above, or be a preset number. The receiver 111 repeats, till the number of the received update requests reaches the specific number (step S302; YES), a reception of an update request and an update of the counter (steps S302; NO, S105; NO, and S301), and the analyzer 112 executes the analysis thereof for every reception of the update request (step S103).

After that, When the number of the received update requests reaches the certain number (step S302; YES), the receiver 111 resets the counter (step S303). After that, as steps S107 to S111 of FIG. 12, update processes of the EPD 13 are executed based on reconstructed update requests, and when the operation should not be finished, the update controller returns to step S101.

As described above, according to the third embodiment, by waiting a certain number of update requests, even when the interval between update requests may be different by every page, it is possible to improve the power performance without being influenced by the difference of the intervals.

In the third embodiment, although the data processing device 1 exampled in the first embodiment is used as a base, it is not limited to such arrangement, and it is also possible to use data processing devices according to the other embodiments as the base.

### Fourth Embodiment

Next, a data processing device, a display device, a semiconductor device, a control method and a program product according to a fourth embodiment will be described in detail with reference to the accompanying drawings. As described before, in order to optimize an update control, hint information may be notified to an update controller. As an instrument for notifying hint information, a function of system call such as “ioctl” in Linux (registered trademark), or the like, can be applied.

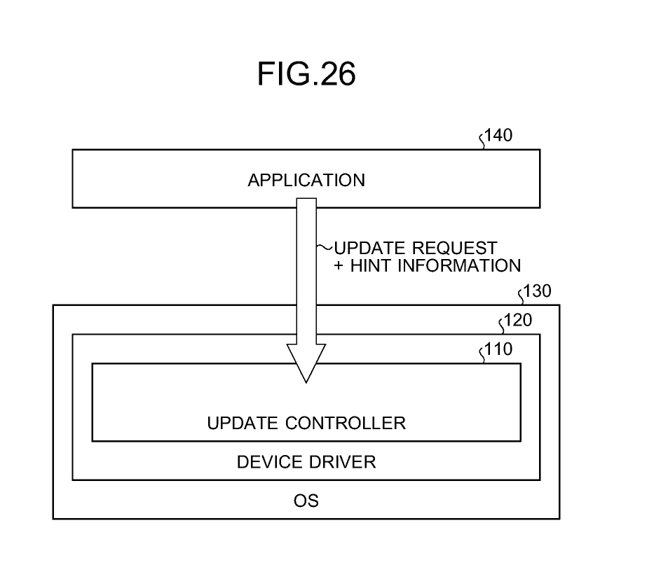

FIG. 26 shows an example of a relationship for notifying hint information between an application 140 and the update controller 110. From the point of view of the application 140, an API (application programming interface) for set hint information is provided. The API can be used at the time of update requests. The hint information may be transmitted with update requests, or be notified at the time of booting the application 140, for instance, separately from update requests. Because the update controller 110 can obtain information from the hint information, which is information that the application 140 can know but the device driver 120 cannot know, the update controller 110 can adjust the update control in more detail.

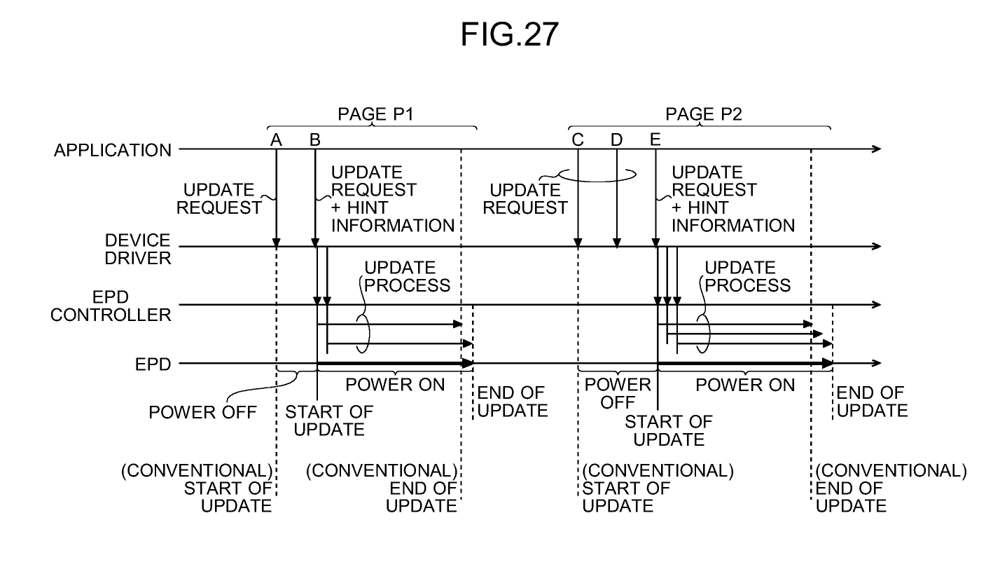

FIG. 27 is an illustration for explaining an outline of a display update operation according to the fourth embodiment and effects thereby. The example shown in FIG. 27 shows a case where a browser is executed on the data processing device 1 shown in FIG. 1, for instance. In FIG. 27, after displaying a page P1, a page P2 is displayed. With respect to the page P1, there are two update requests for regions A and B which do not overlap with each other. To the initial update request for the region A, hint information is not added. On the other hand, to the second update request for the region B, hint information indicating the last of a series of the update requests is added. Likewise, with respect to the page P2, to a third update request for region E, hint information indicating the last of a series of the update requests is added.

As described above, according to the fourth embodiment, by adding the hint information, it is possible to specify an appropriate wait time by the update controller 110. In the browser, the number of update requests and an interval between update requests are different page by page. When there is no regularity as described above, by notifying the last of a series of update requests from the application, it is possible to specify an appropriate timing of reconstruction. As a result, because it is possible to reduce an otiose idle time, it is possible to suppress the extra power consumption and the reduction of usability.

Furthermore, in order to let the update controller 110 wait the hint information indicating the last of the series of the update requests, the update controller 110 is preannounced the coming of the hint information. This can be realized by adding hint information indicating the coming of the update request with the hint information indicating the last to the initial update request of the series update request, for instance.

Furthermore, in the structure where the update controller waits for the specific period of time after receiving the initial update request as the first or second embodiment, by using the hint information described above, it is possible to structure in that grouping and reconstructing are executed directly after the update request with the hint information is received, for instance. As a result, because it is possible to reduce an otiose waiting time, it is possible to realize the further power saving.

Moreover, the hint information can include information indicating that an update request with the hint information is one of serial update requests, i.e., information for specifying a series of update requests. Thereby, even when update requests belonging to different series occurred in the same period of time, it is possible to group and reconstruct them while distinguishing the series. This is the same in the following embodiments.

### Fifth Embodiment

Depending on usage of an update request, an application, or the like, there may be an update request of which a time lag of execution for being displayed on the EPD 13 or the display 23 may reduce the usability and the response performance notably. In such case, the hint information according to the fourth embodiment can improve the usability and the response performance. That is, by notifying an update request of which influence by waiting is large to the update controller from the application, or the like, using the hint information, the update controller 110 can execute the update control and a scheduling in consideration of the usability. In such case, the reconstruction unit 114 of the update controller 110 may reconstruct update requests except for the update request with the hint information, or reconstruct the update request with the hint information and stored update request while a reception of the update request with the hint information is used as a trigger.

### Sixth Embodiment

Furthermore, depending on usage of an update request, an application, or the like, there may be an update request of which abandonment may reduce the usability and the response performance notably, for a displayed content becomes an unintended content. Also, in such case, the hint information according to the fourth embodiment can improve the usability and the response performance. That is, by notifying that an update request requires to be displayed to the update controller from the application, or the like, using the hint information, the update controller 110 can execute the update control and a scheduling while considering the hint information as a restriction.

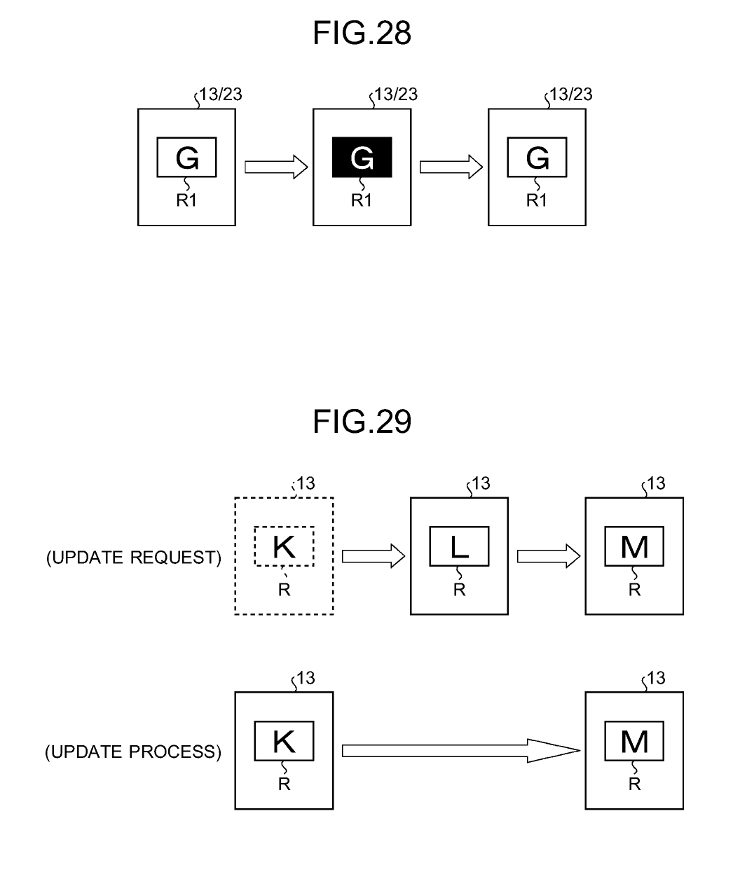

FIG. 28 shows an example of an update request to be displayed. FIG. 28 is an example of a software bottom operated by a user using a touch panel, a keyboard, or the like, which is displayed on the EPD 13 or the display 23. In a normal state, a character “G” being a name of the bottom is displayed as a black character (first state). When the bottom is selected (clicked) by the user, in order to indicate the selection of the bottom to the user, the character changes an outlined character “G” on a black background (second state) temporarily, and returns to the normal black character “G” (third state). In such case, even when the character changes directly to the third state from the first state while skipping the second state, the user cannot know whether the software bottom is selected or not. Therefore, to the update request for changing the character “G” into the second state, hint information for notifying that the update request requires to be displayed is added. Thereby, it is possible to display the second state certainly.

### Seventh Embodiment

As the hint information, utility forms other than the examples in the fourth to sixth embodiments will be exampled.

The hint information can be used as a tool for notifying that an update request can be abandoned, for instance. By notifying from the application to the update controller that the update request can be abandoned, because flexibility at the update controller becomes greater, it is possible to further improve the power consumption and the usability.

Furthermore, the hint information can also be used as a tool for notifying the update controller which of the power consumption and the response performance has how much priority. In the update control executed by the update controller, the power consumption and the response performance may have a trade-off relationship. For example, a solar-powered data processing device requires a tight restriction in power. Therefore, by notifying the update controller which of the power consumption and the response performance has how much priority, it is possible to let the update controller execute an update control such that when a power generation amount is small, the power consumption is given priority, and when a power generation amount is enough, the response performance is given priority. Furthermore, it is also possible to create an application capable of switching the update control based on such power condition.

### Eight Embodiment

When two update requests for updating the same region of the EPD 13 or the display 23 are issued at a short interval, an update process is executed once, and as a result, a result of a latter update process is displayed on the EPD 13 or the display 23.

FIG. 29 shows an operation example in a case where two update requests for updating the same region of the EPD 13 are issued at a short interval. In FIG. 29, a character “K” is displayed on a regions R in an initial state. Firstly, an update request for updating the region R using data of a rectangular image including a character “L” is issued. Then, an update request for updating the region R using data of a rectangular image including a character “M” is issued. In such case, the EPD controller 105 executes only an update process using the data of the character “M”. Therefore, an actual content displayed on the EPD 13 changes directly to the letter character “M” from the initial character “K”.

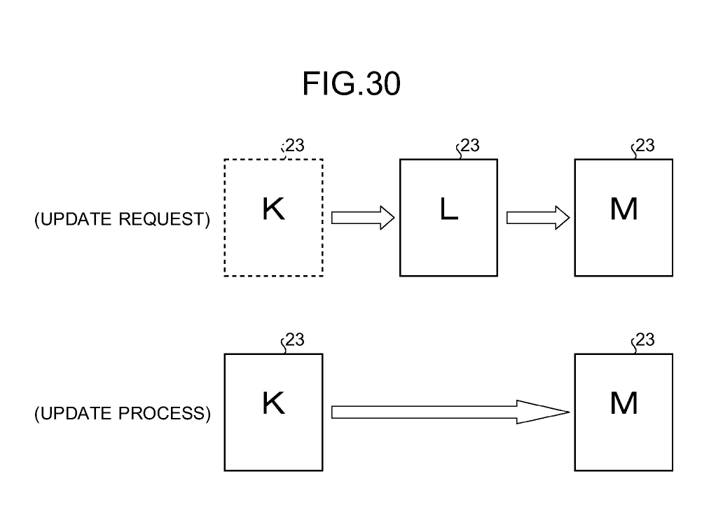

FIG. 30 shows an operation example in a case where the above-described update request is issued on the data processing device 2 with the display 23 being the low refresh rate display. In FIG. 30, a character “K” is displayed on the display 23 in an initial state. Firstly, an update request for updating the whole screen of the display 23 using data of a rectangular image including a character “L” is issued. Then, an update request for updating the whole screen of the display 23 using data of a rectangular image including a character “M” is issued. In such case, the EPD controller 205 executes only an update process using the data of the character “M”. Therefore, an actual content displayed on the display 23 changes directly to the letter character “M” from the initial character “K”.

As described above, by executing the last update request in the update requests issued at short intervals without executing the middle update requests, it is possible to shorten the update time. Thereby, because it is possible to reduce the power consumption for updating the display and extend the idle time for the aggressive power saving, it is possible to improve a power performance of the data processing device with the display.

### Ninth Embodiment

Next, a data processing device, a display device, a semiconductor device, a control method and a program product according to a ninth embodiment will be described in detail with reference to the accompanying drawings. In the ninth embodiment, the number of update processes is recorded as a history for every action, and the appropriate number of update requests is dynamically changed by referring to the history.

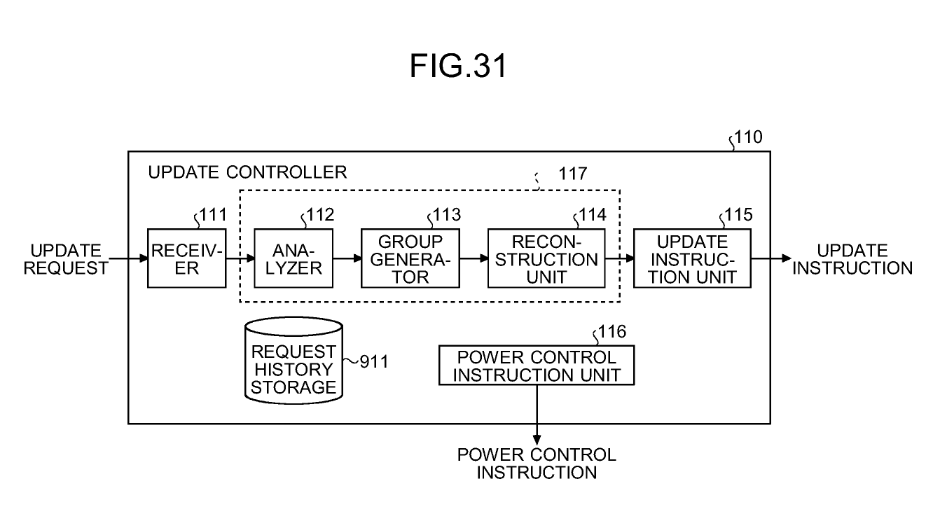

FIG. 31 is a block diagram showing an example of an outline structure of an update controller according to the ninth embodiment. As shown in FIG. 31, the update controller 110 according to the ninth embodiment has a request history storage 911 for storing contents of update requests and the number of a serial update requests as a history in addition to the same structure as the update controller 110.

The update controller 110 stores contents of past update requests and the number of a serial update requests as a history. The history stored in the request history storage 911 is used for automatically adjusting a waiting time of update requests for grouping, the number of update request per group, or the like. Thereby, because it is possible to generate appropriate update request groups automatically, it is possible to realize a data processing device with automatically learning function capable of adapting actions of the application, or the like. For example, when the application program explained using FIG. 28 in the sixth embodiment is executed iteratively, displayed contents actually displayed on the display are changed between the ones in the initial several times and the ones in the followings thereafter. The several times may be one time, two times, or the like, for instance.

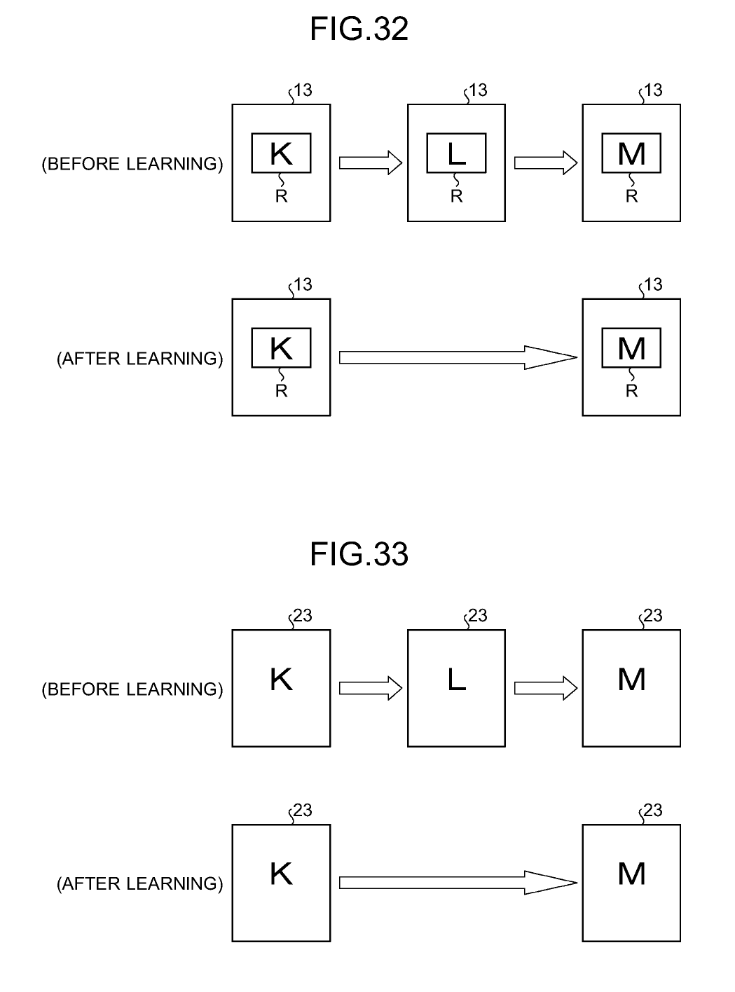

FIG. 32 shows an example in a case where an application program issuing the update requests according to the sixth embodiment is repeatedly executed on the data processing device 1 with the EPD 13 according to the first embodiment. As shown in FIG. 32, at a stage before learning using the history, on the EPD 13, the characters “K”, “L” and “M” are displayed in this order. After that, by learning, the character “M” is displayed directly after the initial character “K” on the EPD 13. In this way, when the two update requests for updating the same region R are repeatedly executed in a short time, the number of execution of update processes, which is twice before the learning, becomes once after the learning.

FIG. 33 shows an example in a case where an application program issuing the update requests according to the sixth embodiment is repeatedly executed on the data processing device 2 with the display 23 according to the second embodiment. As the example shown in FIG. 32, in the example shown in FIG. 33, at a stage before learning using the history, on the display 23, the characters “K”, “L” and “M” are displayed in this order. After that, by learning, the character “M” is displayed directly after the initial character “K” on the display 23. In this way, when the two update requests are repeatedly executed in a short time, the number of execution of update processes, which is twice before the learning, becomes once after the learning.

As described above, by automatically generating an appropriate update request group by the learning function using the history, it is possible to shorten the update time. Thereby, because it is possible to reduce the power consumption for updating the display and extend the idle time for the aggressive power saving, it is possible to improve a power performance of the data processing device with the display.

### Tenth Embodiment

Next, a data processing device, a display device, a semiconductor device, a control method and a program product according to a tenth embodiment will be described in detail with reference to the accompanying drawings. In the above-described embodiments, update requests of which update target regions are separated are not combined in the reconstruction of update requests. However, it is not limited to such arrangement, and it is also possible that all update requests are combined by converting update target regions thereof into a single rectangular region including the all update target regions, for instance.

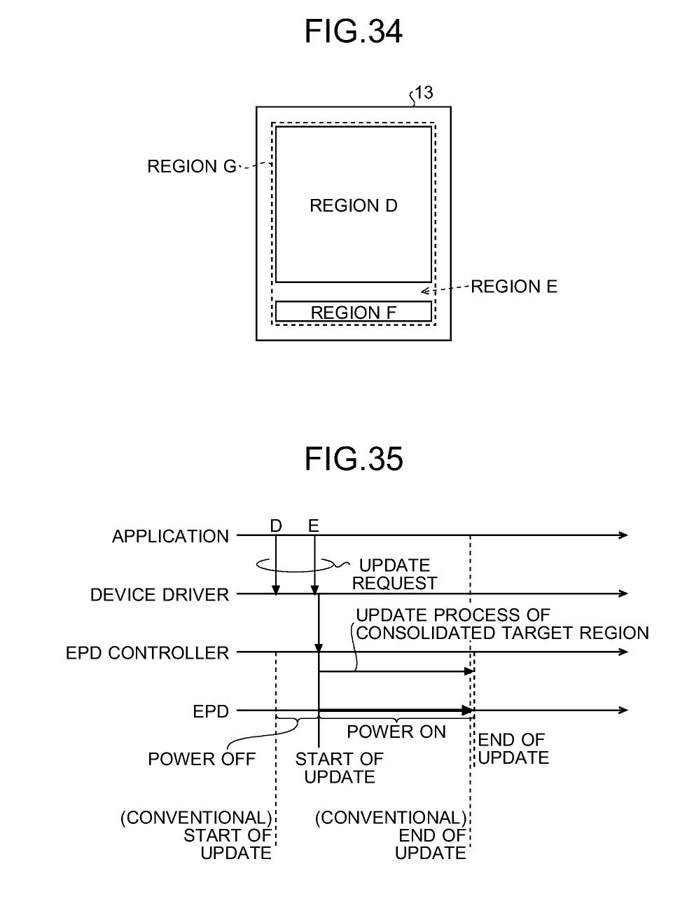

FIG. 34 is a diagram showing a case where update requests of regions D and F, which have the same width and are separated from each other, are issued in a short time. As shown in FIG. 34, for example, when update requests of the regions D and F are issued after data of the regions D and F are stored in a frame buffer, by converting the regions D and F into a region G including the regions D and F, it is possible to convert the update processes into a single update process. However, when the update requests of the regions D and F are issued after data of the regions D and F and data of a region E located between the regions D and F are stored in the frame buffer, the data of the region E, which should not be displayed in the intention of the application, may be displayed by updating the region E. In such case, by notifying information indicating whether separated regions can be combined positively or not from the application to the update controller as hint information, it is possible that the update controller optimizes the update control without consideration of the possibility of an unintended data being displayed.

FIG. 35 is an illustration for explaining an outline of a display update operation according to the tenth embodiment and effects thereby. After the update request of the region D, by waiting an arrival of the update request of the region F, and executing the two update requests at one time without combining of the two update requests, as described in the above-described embodiments, because starts of update processes are concentrated, the update time becomes short, and as a result, the power saving can be realized. On the other hand, as shown in FIG. 35, the reconstruction of the update requests into a single update request by combining the regions D and F converts the update processes into a single update process, and thereby, the update time become the shortest because an offset between the starts of the update processes is canceled. Accordingly, it is possible to realize further power saving.

Furthermore, By converting the update requests into a single update request, it is also possible to convert the above-described pre-processes required for every region into a single pre-process. Especially, in a case where the number of update requests (the number of regions) is large, the pre-process is executed by software, or the like, an overhead of the pre-process is also large. Therefore, by converting the pre-processes into a single pre-process, it is also possible to reduce overheads of the pre-processes. Accordingly, it is possible to realize further power saving. Here, based on the number of update processes, the processes of converting and not converting can be switched.

The number of the above-described update engines is limited. Therefore, when the number of the update requests is large, the number of update engines may not be enough, and the update processes may be put on hold. Therefore, when the conversion of the separated regions can cancel the waiting of the update processes due to the lack of the update engines, it is possible to shorten the update time. As a result, it is possible to realize the further power saving. This is not limited to the tenth embodiment. That is, such realization of the further power saving enabled by shortening the update time by canceling the waiting of the update processes due to the lack of the update engines by converting the update processes can be applied to the other embodiments. Also, with respect to this, based on the number of update processes, it is possible to switch converting and not converting.

### Eleventh Embodiment

Next, a data processing device, a display device, a semiconductor device, a control method and a program product according to an eleventh embodiment will be described in detail with reference to the accompanying drawings. In the above-described embodiments, although the update controller instructs update processes in one time by combining a plurality of update requests, in an application letting a user draw comments, characters, or the like, by hand, pen input, or the like, when update processes do not follow actions of a pen, or the like, smooth scrolling may be impossible. Therefore, in such application which attach weight to the response performance, update processes should be executed without delay.

As a tool for instructing the update controller so that update processes are executed without delay, the hint information exampled in the fourth embodiment can be used. In an application where update processes except for update processes caused by handwriting will not be occurred, at the time of booting the application, for instance, the application may transmit hint information to the update controller for instructing that every update processes with respect to update requests after booting the application should be immediately executed without waiting. The application can also transmit hint information to the update controller for instructing that every update processes with respect to update requests targeting a specific region on the display should be immediately executed without waiting.

In an application for noting on an electronic book or a PDF file by handwriting while reading them, or the like, update processes by the handwriting and other update processes may be mixed. In such case, hint information indicating that this update request is the above-described update request to be immediately executed may be added to update requests of handwritten lines.

In another method other than the above-described method using the hint information, it is also possible to structure in that whether an update request is occurred by handwriting or not is automatically discriminated based on a size of an update target region targeted by an update request, and an update request discriminated as one occurred by handwriting is instructed to execute immediately. The discrimination whether it is occurred by handwriting can be executed by comparing a size of an update target region and a preset size by the analyzer 112, for instance.

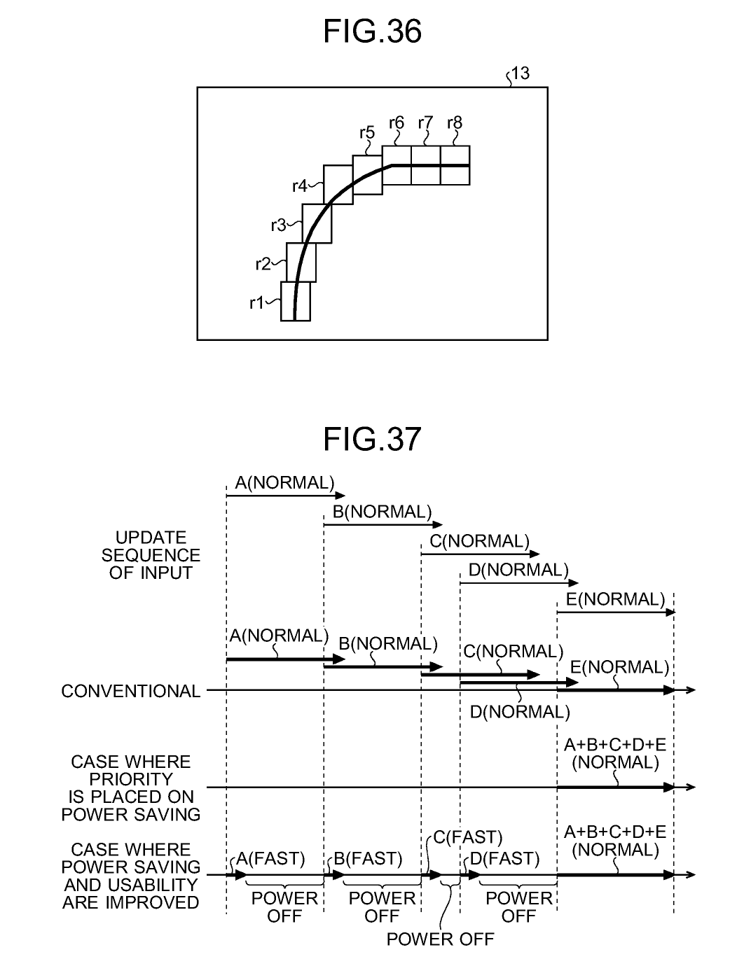

FIG. 36 shows an example of an update operation by handwriting in a case where an EPD capable of executing partial update processing and parallel update processing is used as the EPD 13. As shown in FIG. 36, because the response performance is important in handwriting, the application issues update requests of small rectangular regions r1 to r8 on which handwriting is executed for every specific period of time. On the other hand, in the update controller, the response performance is improved by executing update processes in parallel. In order to improve the response performance, the size of each of the rectangular regions r1 to r8 should be small. Therefore, the update controller can automatically determine whether an update request is occurred by handwriting or not based on a size of a region targeted by each update request.

### Twelfth Embodiment

Next, a data processing device, a display device, a semiconductor device, a control method and a program product according to a twelfth embodiment will be described in detail with reference to the accompanying drawings. As an operation mode of an EPD, there are a normal update mode in which a residual image with flashing, or the like, is not remained but an update time is long, and a high-speed update mode in which update speed is comparatively fast but a residual image is remained. In the twelfth embodiment, by using the high-speed update mode conveniently, the response performance and the power saving are supported at the same time.

FIG. 37 shows an example of an update operation in a case where a web page is obtained and displayed by a browser, or the like. As shown in FIG. 37, in a browser, or the like, data about a single page is separately transmitted. Therefore, it takes time to obtain the whole data. In such case, as shown at “CONVENTIONAL” in FIG. 37, in a method where received data is displayed in the normal mode in order of reception, because images without residual image and characters are displayed in order of arrival, although the response performance and the usability are high, because some kind of update process is continuously executed, and thereby the EPD 13 and the associated modules thereof are powered on, the power consumption is large.

Therefore, when the power saving is important, as shown at “CASE WHERE PRIORITY IS PLACED ON POWER SAVING” in FIG. 37, by combining regions after all pieces of data about a single page are received so that the number of update processes becomes 1, it is possible to shorten the update time, and thereby, it is possible to suppress the power consumption.

Furthermore, when the response performance and the usability are considered in addition to consideration of the power saving, as shown at “CASE WHERE POWER SAVING AND USABILITY ARE IMPROVED” in FIG. 37, received data are displayed in the high-speed update mode in order of reception, and when all pieces of data about a single page have been received, the regions are combined and a single update process is executed in the normal update mode. Because the update time in the high-speed update mode is short, it is possible to set the low power state such as turn-off of the EPD 13 and the associated modules, or the like, during the update process in the high-speed update mode. Thereby, while the residual image is remained a little, it is possible to realize the power saving while the response performance and the usability are improved. Furthermore, by executing an update process once by combining regions after all pieces of data about a single page are received, for instance, i.e., by updating the regions updated in the high-speed update mode in the normal update mode, finally, the residual image can be removed. A last timing of update in the normal mode may be notified from the application such as the browser, or the like, or may be decided based on a reception waiting time of a next update request. By executing such update control by the update controller, it is possible to realize the improvement of the response performance and the usability and the reduction of the power consumption in a balanced manner.

### Thirteenth Embodiment

Next, a data processing device, a display device, a semiconductor device, a control method and a program product according to a thirteenth embodiment will be described in detail with reference to the accompanying drawings. By storing the past update requests as the history as in the ninth embodiment, it is possible to execute a advanced collision analysis using the history. As a result, because collisions can be removed appropriately, it is possible to improve the usability with suppression of the power consumption.

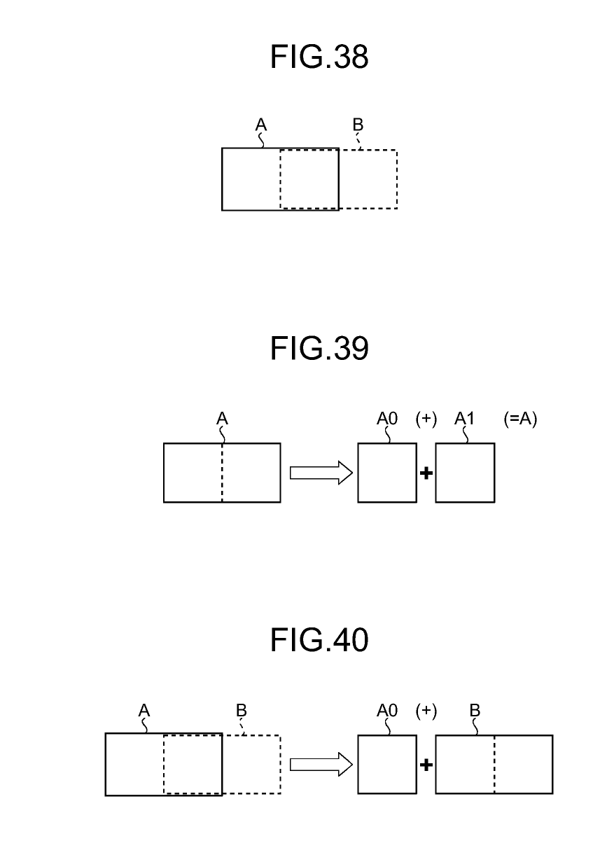

An example of a display update control for realizing a collision removal will be described in the following. FIGS. 38 to 41 is diagrams showing an example of a display update control in a case where two update requests which will cause a collision are issued with respect to regions A and B which overlap with each other.

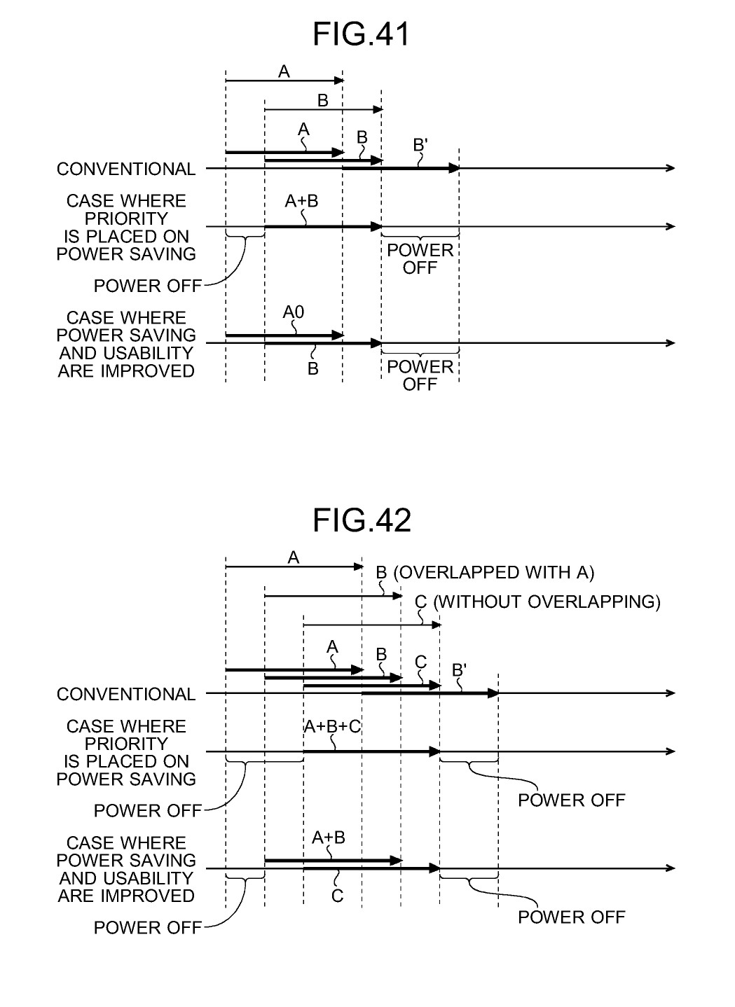

As shown in FIG. 38, it is assumed that the update request of the region A and the update request of the region B are issued in this order. In a comparative example where the update controller 110 does not optimize the display update control, as shown at “CONVENTIONAL” in FIG. 41, although update processes of the regions A and B are executed directly after the update requests are arrived, the update process of the region B collides with the update process of the region A. Therefore, after the region A is updated, an update process (B′) of the region B should be executed again. As a result, by such collision, the update time becomes long.

On the other hand, when the update controller 110 optimizes the display update control, as shown in FIG. 39, the region A of the prior update request in the two update request which will cause the collision is divided into two regions A0 and A1 based on the overlap with the region B. As a result, as shown in FIG. 40, the update requests of the regions A and B are reconstructed into update requests of the regions A0 and B, and further reconstructed into an update request of a region combining the regions A0 and B. Thereby, as shown at “CASE WHERE PRIORITY IS LOCATED AT POWER SAVING” in FIG. 41, after the update request of the regions B is arrived, the update process of the region combining the regions A and B is executed. According to such method, because it is possible to shorten the update time while avoiding the collision, it is possible to realize the power saving.

Furthermore, as shown at “CASE WHERE POWER SAVING AND USABILITY ARE IMPROVED” in FIG. 41, it is also possible that the region A is divided into the regions A0 and A1, an update process of the region A0 which will not cause a collision is started before the update request of the region B is arrived, and after the update request of the region B is arrived, the regions A1 and B are combined, and the update process of the combined region is executed. According to such method, because it is possible to shorten the update time while avoiding the collision, it is possible to realize the power saving, and furthermore, because the region A0 is updated first, it is possible to improve the response performance and the usability.

As described above, the reconstruction unit 114 can optimize the display update control by dividing the update target region. Information about a position of the overlap of the regions A and B may added to the update request of the region A as hint information, for instance.

Another example of the display update control for realizing a collision removal is shown in FIG. 42. In FIG. 42, by executing a collision analysis based on the history, the usability is improved. Furthermore, in FIG. 42, it is assumed that update requests of regions A, B and C are inputted, the region A and the region B overlap with each other, and the region C does not overlap with both the regions A and B.

As shown at “CONVENTIONAL” in FIG. 42, in a comparative example without optimization of an input sequence to the display update control, because an update process of the region A and an update process of the region B are collided with each other, the update process of the region B should be executed again after the update process of the region A is finished. As a result, the update time becomes long, and thereby, the power consumption increases.

On the other hand, as shown at “CASE WHER PRIORITY IS LOCATED AT POWER SAVING” in FIG. 42, in a method with optimization of an input sequence to the display update control, after the update requests of all of the regions A to C are received, the regions A to C are combined, and a single update process of the combined region is executed. Thereby, because it is possible to avoid a collision, the update time can be shortened, and as a result, it is possible to suppress the power consumption.

Furthermore, as shown at “CASE WHERE POWER SAVING AND USABILITY ARE IMPROVED” in FIG. 42, in a method where the usability are improved while the input sequence to the display update control is optimized, the regions A and B are combined at the time when the update requests of the regions A and B which will cause a collision, and an update process of the combined region is executed at one time. That is, the update request of the region A and the update request of the region B are grouped into the same update request group. Because the region C does not overlap with the other regions A and B, even when the update request of the region C is directly executed at the time when the update request of the region C is arrived, no collision occurs. According to such method, because it is possible to avoid occurrence of collisions, it is possible to realize the power saving by shortening the update time, and because it is possible to execute the update processes of the regions A and B without waiting the arrival of the update request of the region C, it is possible to improve the usability by improving the response performance.

As described above, even when the usability, the response performance and the power saving have the trade-off relationship, it is possible to optimize the display update control depending on the situation. For example, in the solar-powered data processing device, or the like, by dynamically change a control method based on a remaining battery power of an accumulator such as a capacitor, or the like, and a power generation amount of a solar cell, it is possible to improve the usability and the response performance while letting the data processing device operate stably under tight power restriction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing device comprising:
a processor that reconstructs a plurality of update requests for updating at least a part of a display into one or more update requests, or determine that the plurality of the update requests are unnecessary; and
an update instruction unit that instructs to execute update processes of the display using the reconstructed one or more update requests.

2. The device according to claim 1, wherein
the processor includes
a receiver that receives the plurality of the update requests from an external;
an analyzer that analyzes the plurality of the update requests received by the receiver;
a group generator that groups the plurality of the update requests based on an analysis result of the analyzer; and
a reconstruction unit that reconstructs the plurality of the update request by each group generated by the group generator.

3. The device according to claim 1, further comprising a power control instruction unit that switches a power to be fed to the display from a first power to a second power which is greater than the first power during the update processes of the display are executed, wherein
the second power is a power capable of executing an update process of the display.

4. The device according to claim 2, wherein the group generator groups update requests which are close in terms of time into a single group.

5. The device according to claim 2, wherein
the analyzer specifies an update target region of each update request, and
the reconstruction unit reconstructs update requests included in each group into one or more update requests targeting one or more update target regions including update target regions of the update requests included in the respective groups.

6. The device according to claim 2, wherein
the analyzer specifies an update target region of each update request, and
the reconstruction unit generates one or more new update target regions by dividing and/or combining the update target regions included in each group, and reconstructs the update requests included in each group into one or more update requests of the one or more new update target regions.

7. The device according to claim 2, wherein
the analyzer specifies update target regions of each update request, and
the group generator groups the plurality of the update requests so that update requests of which update target regions overlap with each other are grouped into the same group.

8. The device according to claim 2, further comprising a request history storage that stores a history of past update requests, wherein
the group generator groups the plurality of the update requests based on the history stored in the request history storage.

9. The device according to claim 2, wherein
the display executes a periodical refresh of a screen, and
the reconstruction unit abandons an update request which is close to the periodical refresh in terms of time.

10. The device according to claim 1, wherein the display is an electronic paper.

11. The device according to claim 1, wherein the display has a refresh function.

12. The device according to claim 1, wherein at least one of the plurality of the update requests include hint information.

13. The device according to claim 12, wherein the hint information includes information indicating that an update request including the hint information is an initial update request or a last update request in a series of update requests.

14. The device according to claim 13, wherein the hint information further includes information for identifying the series of the update requests.

15. The device according to claim 12, wherein the hint information includes information indicating that the update request with the hint information is an update request to be displayed immediately.

16. The device according to claim 12, wherein the hint information includes information indicating that the update request with the hint information requires to be displayed certainly.

17. The device according to claim 2, wherein
the analyzer determines whether a size of the update target region of each update request is smaller than a specific size or not, and
the update instruction unit instructs, with respect to an update request of which size of the update target region is smaller than the specific size, to execute an update process thereof without reconstruction by the reconstruction unit.

18. A display device that executes a single update process in response to two update requests with different issuance times and the same update target region.

19. A display device that executes two update processes in response to two update requests with different issuance times and the same update target region, and then, when two update requests to the same update target region are issued again, execute a single update process with respect to the reissued two update requests.

20. A display device in which update times of two regions are different depending on a battery power of an accumulator installed in a data processing device outputting an update request.
